(19) United States
(12) Patent Application Publication
(10) Pub. No.: US 2016/0225086 A1
(43) Pub. Date: Aug. 4, 2016

(54) PERSONALIZED INVESTMENT PORTFOLIO BUILDER AND INVESTMENT STRATEGY TESTER

(71) Applicant: Michael W. SEITZ, Bellaire, TX (US)

(72) Inventor: Michael W. Seitz, Houston, TX (US)

(21) Appl. No.: 15/023,016

(22) PCT Filed: Sep. 20, 2014
(86) PCT No.: PCT/US14/56698

§ 371 Date: Mar. 18, 2016

Related U.S. Application Data
(60) Provisional application No. 61/960,549, filed on Sep. 20, 2013.

(51) Int. Cl. G06Q 40/04

(52) U.S. Cl. CPC G06Q 40/04

(57) ABSTRACT

The invention provides a method comprising (a) opening an ideas Vault, {b) creating an investment portfolio in the vault, (c) allocating an investment amount to the portfolio, (d) creating a basket in the portfolio, (e) allocating part of the investment amount to the basket, (f) selecting an investible for the basket, (g) repeating step (f) with different investibles to populate the basket, (h) apportioning the basket cash allocation between the investibles on a percentage basis, (i) repeating steps (d)-(h) to form different baskets, (j) reallocating cash between different baskets if desired, (k) moving the portfolio to the Serious Stuff Vault, (I) selecting a broker, (m) executing purchase of the portfolio, (n) broker moving the executed portfolio to user's Action Vault, and (ol user being able to make modifications by repeating steps (k)-(n) with an indication to the broker that the modified portfolio is to be a replacement.

### TECHNICAL FIELD

Preferred embodiments of the invention relate to formulating electronically tradable virtual investment packages, graphing their historical performance, evaluating and monitoring these investment packages, and producing games involving user-created virtual investment packages. The preferred embodiments then envision buying and selling such virtual formulations between users and providing a means for a formulator to trade such investment packages electronically in the real world. Generally, knowledge research tools such as news, commentary, and any other data for individual tradables (or links electronically provided to such resources) can be incorporated into the system for easing research during formulation. The invention is carried out on a computer and is suitable for small computing devices such as smart phones and tablets as “apps.”

### BACKGROUND ART

While investors can easily evaluate, buy, and sell individual stocks and other individual investibles electronically, there are not many tools available to the public that enable them to virtually formulate personal and unique combinations of electronically tradable investments nor unique and definable rebalancing strategies for the virtual formulations. In addition, once these strategies are formulated, there are not many aggregation tools to simply consolidate, quickly modify, and evaluate the historical performance of such derived, virtual packages of investments as unitary packaged entities as would typically be promoted by professional fund creators and managers who offer such basket investments in the real world. Such investing strategies are promoted to encourage diversification, but tools to easily personally develop and historically evaluate such derived strategies are not currently available in simple application format. For this reason, investment houses, for example, have developed a strong market position in exchange traded funds (ETFs) that trade as unitized entities comprising weighted baskets of stocks and other trade items.

Further, there is no available means to directly offer or to purchase such user-created formulation blueprints in a store in an electronically importable and editable form for private use, adaptation, and combination into other existing investment portfolios.

The invention described gives a nonprofessional or professional investor an opportunity to formulate and develop simple or complex virtual baskets of investibles. Such investment packaging would typically be time consuming and extremely difficult for an investor using currently available computer tools and data, since data and tools are commonly available only for single-item evaluation and historical performance tracking rather than for bundles of items, the focus of this invention.

Competitive gaming, which can demonstrate skill and make formulations attractive to others and electronically provide forums for enjoyment and entertainment, are also not currently offered for bundled virtual investment creations.

An object of this invention is to electronically provide tools to enable investors to formulate their own virtual investment packages similar to ETFs and to cooperatively share their formulations with other investors and/or compete with them in investment-based games if they so desire, and then to electronically provide a means to communicate the virtual formulations with firms who are licensed to trade on behalf of the creators of the formulations and reduce the virtual formulations to reality.

### DISCLOSURE OF INVENTION

One embodiment of the invention electronically provides an online store where a shopper can purchase virtual investment formulations. The store offers an inventory of different virtual investment baskets originating from different authors. The full basket descriptions, which include the individual tradable item names and relative weightings and optional reweighting strategies, are not visible or disclosed prior to purchase, but rather are advertised for purchase by electronic display of their characteristics and historical performance charts in the online store. The historical performance charts electronically presented to potential purchasers by the store are user-amendable, tailored performance charts for each unique offering described as a “basket” in the online store. The baskets are similar to ETFs, except that the actual investibles (meaning securities or currency) in the virtual formulation have to be acquired by the purchaser as discrete weighted components of the formulated basket in a separate step if the basket is to be transformed into a real investment because what the store typically electronically sells are virtual formulations rather than the singular tradable investments themselves. The baskets are privately originated investment formulations and are not sold on exchanges. However, a brokerage can sell the baskets and the actual investibles directly if the store offers such brokerage house services. The baskets each comprise a number of units of each of at least a first electronically traded investible and a second electronically traded investible, with the specified relative weightings at the specific point in time determining the number of units of each. The relative weightings of the investibles on a dollar basis fluctuate over time, and the basket can be offered by the store with a reapportionment strategy.

The store forms a sort of cooperative for the baskets in the form of a remotely electronically accessible program or Internet Web page sponsored by a host site for electronically posting user-defined virtual investment basket formulations and host-site-generated and presented performance information which can be viewer tailored for analysis or evaluation prior to electronic purchase. As noted before, the baskets have a composition comprising weighted amounts of at least a first electronically tradable investible and a second electronically tradable investible, preferably with an associated reapportionment strategy. To promote baskets for sale, they can be catalogued by electronically searchable user tags and descriptions along with automatically computer-generated characterizations which are searchable by users browsing the electronic store. The library of offerings is electronically displayed as index charts appearing on the user's electronic display device like the covers of books, with the ability to more closely explore an item of interest by clicking on an electronic displayed item. Following this, a detailed description and amendable performance chart for analyzing the basket performance information appears as an image on the user's electronic display along with a hot area to receive a purchase command for electronic transmittal to the host site. The optional formulation and rebalancing strategy of the basket offered for sale is fixed, but the charted historical performance of such a formulation is dependent on the starting investment date and the investment period, both of which can be set by the purchaser reviewing the basket's historical performance. On an electronic display associated with the user's digital computer, the store electronically provides an image of a default cash value graph of the value of the basket against time as well as hot areas to adjust the investment starting date and investment period for the basket. That permits the user to test the basket historically against various market conditions such as inflationary periods or market crashes. Computer-generated details pertaining to the character of the investibles can be included in the descriptors to ensure the offering is suitable for a potential purchaser's area of interest.

The store can also electronically provide for purchase descriptions of arbitrage pairings of baskets. This service is electronically provided in the form of a remotely electronically accessible or downloadable program or Internet Web page sponsored by the host site for posting user-defined performance information for virtual investment basket pairings. Each virtual basket pairing includes a first virtual basket comprising at least one first electronically tradable investible and a second virtual basket comprising at least one second electronically tradable investible. The remotely electronically accessible program or Internet Web page is presented via the Internet or other electronic information highway as an image on the user's electronic display of a default cash value graph of the difference in change in the first virtual basket's starting unitary cash value and the change in the second virtual basket's starting unitary cash value. The difference is expressed as a percentage change. The image further includes a hot area to electronically transmit an electronic access command to purchase a description of the first virtual basket and the second virtual basket formulations, in other words, the virtual baskets.

Hot areas are also electronically provided for receiving commands to adjust the investment starting date for each basket. This permits a user to evaluate the relative performance of the baskets historically against various market conditions such as inflationary periods or market crashes.

Another embodiment of the invention electronically provides an organizer system in the form of multiple virtual electronic workspaces. The system comprises a computer program operating in conjunction with a digital computer system to electronically provide a visual interface displaying screen icons which locate hot areas for launching the virtual electronic workspaces. One icon is electronically provided for each hot area, and one hot area is electronically provided for each virtual electronic workspace. Each virtual electronic workspace is preferably password protected and facilitates carrying out specific definable work functions and storage. The virtual electronic workspaces are used for different purposes. Opening a virtual electronic workspace by virtual unlocking using a password permits a user to electronically access directories containing data and formulations utilised by the core applications of the virtual electronic workspace to calculate and electronically display performance graphs on the user's visual interface for virtual investment formulations. Each virtual investment formulation is comprised of apportioned/weighted percentage holdings of electronically tradable investibles including at least a first electronically tradable investible and a second electronically tradable investible, preferably together with reapportionment strategies.

The virtual electronic workspaces are herein referred to as “vaults” when they are password protected. The vaults are given names herein to facilitate differentiation of them from each other. However, abstractly, they could be simply referred to as first, second, third, etc. vaults without changing the meaning. An icon is electronically provided for a password-protected “Store Vault” which comprises a virtual electronic workspace permitting electronic access to resources for electronically acquiring data and other authors' formulations of electronically tradable investibles. Another icon electronically provides access to a password-protected “Ideas Vault” which comprises a virtual electronic workspace for a user formulating packages of investibles. A further optional icon electronically provides access to a password-protected “Serious Stuff Vault” which includes a virtual electronic workspace functioning as an area for testing developed formulations and reapportionment strategies and for electronically transmitting descriptions to third parties for actual trading action and execution of reapportionment strategies in reality. A further icon electronically provides access to a password-protected “Action Vault” which comprises a virtual electronic workspace providing an archive of past and current real investments originating from user-created virtual formulations developed within various other virtual electronic workspaces and electronically transmitted by the program to third parties for actual acquisition. A further optional icon electronically provides access to a password-protected “Games Vault” which comprises a virtual electronic workspace providing electronic access to investment games involving user-created formulations against third parties. Formulations residing in any virtual electronic workspace can be electronically copied from any other area or vault and electronically pasted into another area other than the Action Vault or Store Vault. Formulations appearing in these vaults are controlled by the electronic host.

Each of the above vaults is provided with an operably associated dedicated computer electronic memory storage area and electronic access to data sets of historical unit trading prices for electronically tradable investibles. They are all provided with the ability to electronically duplicate, remove, and modify existing baskets; to electronically form virtual baskets of weighted amounts of electronically tradable investibles; to electronically adjust the weightings; to electronically graph the past performance of the baskets; to electronically form virtual portfolios containing at least one virtual basket; and to electronically save information for subsequent use. The Serious Stuff Vault electronically provides a hot button that has the capability of electronically transmitting investment portfolio information to a third-party site with a request to execute a purchase of the composition of the investment portfolio and thereby reduce the portfolio to reality. The Action Vault is reserved for automatically electronically storing records for executed real investment portfolios where the user has acquired the investibles using the Serious Stuff Vault via hot button transmission and preferably a suitable return verification of execution to the host program. Records of traded portfolios are electronically placed in the Action Vault automatically by the host software for the user to use as a performance tracking tool and as a locked portfolio description that can be electronically copied later into the Serious Stuff Vault. This copy will be electronically linked to the original portfolio so that any desired modifications to an existing real portfolio can be electronically transmitted for real-world trading accounting of the existing real investments and any trading requirements optimized to achieve the new modified portfolio formulation. In a preferred arrangement, records for the baskets contained in portfolios electronically appearing in the user's Action Vault are automatically placed in the online Store Vault for purchase by others. Portfolios electronically copied from the Action Vault and electronically pasted into the Ideas Vault are no longer linked to the Action portfolio and are considered new, independent formulations under development. The Action Vault has an electronic lock placed on the portfolio information that relates to the make-up of the executed formulations once notification of execution has been received from the third-party site. Any formulation can be deleted, and upon deletion is electronically copied to a “Deleted Items” vault. A deleted items virtual electronic workspace or password-protected vault, if password protected, can be used for archiving and for retrieving items deleted accidentally or needing later recovery. The deleted items vault can be electronically displayed in a less conspicuous manner.

One method of using the just-defined Ideas Vault system includes electronically forming a named, virtual empty investment portfolio in the Ideas Vault, then from within this portfolio's computer storage work space electronically forming a virtual basket of weighted amounts of electronically tradable investibles in the named portfolio, electronically copying the developed portfolio, and electronically pasting the copied portfolio into the Serious Stuff Vault. Alternatively, a developed virtual basket residing in a named portfolio in any vault can also be electronically copied and electronically pasted as a virtual basket into an existing portfolio, which then forms a modified portfolio including the virtual basket (or a modified form of the virtual basket) in the Serious Stuff Vault. Electronically apportioning relative virtual investment values between investibles in baskets, electronically implementing an automatic strategy associated with the basket reweighting, or electronically adjusting allocations between baskets in virtual investment portfolios can be achieved by electronically ascribing new monetary or percentage values of a total value, electronically amending a system default unitary value with a default equal apportionment, or by electronically applying reweighting strategies. By pressing a hot button ideally associated with the copy and paste function, a copy of the portfolio information can be electronically transmitted from the Serious Stuff Vault to the third-party site with an indication of interest in purchasing the composition of the portfolio.

Another method of using the just-defined vault system comprises electronically copying a portfolio in the Action Vault, electronically pasting the copied portfolio into the Serious Stuff Vault, electronically modifying the portfolio in the Serious Stuff Vault, determining whether the modified portfolio is to replace the originally copied portfolio, and if yes, pressing the hot button and electronically transmitting the modified portfolio to a third-party site with instructions to replace the originally copied portfolio in a suitably optimized manner which minimizes trading volume to achieve the new desired formulation in real-world investibles.

Where the third-party site is a host which acts as an intermediary between the user and a broker, the host will generally electronically receive from the user a description of a user-defined virtual investment portfolio. The portfolio will comprise at least one virtual basket, each of which has a virtual investment starting cash value and a composition comprising weighted amounts of at least a first electronically tradable investible and a second electronically tradable investible. The basket will have no automatic reweighting strategy unless specifically created. The identity and initial weighted amount of each electronically tradable investible is included in the description along with any potential reweighting strategy if such a feature can be accommodated by the third party. In addition, an indication of a desire to purchase the composition of a portfolio is electronically received from the user. An order to purchase the composition along with the formulation of the portfolio to be purchased for the user is electronically made available to a broker. The user and broker can modify through a suitable means the actual final cash value of any basket investments, thus providing a simple means of privacy for the user with respect to the host.

The broker electronically receives from the host or the user a description of a user-defined virtual investment portfolio. The portfolio comprises at least one basket, each of which has a virtual investment starting cash value and a composition comprising weighted amounts of at least a first electronically tradable investible and a second electronically tradable investible. The broker also electronically receives from the user or from the host on behalf of the user an order for the real-world composition of the portfolio.

For a first-time user, the above real-world investing method steps are preceded by the broker electronically receiving a request to establish an electronic user account and if required, establishing the account. Such information can be securely saved by the host for easy retrieval later by the user.

The system electronically provides a means to electronically offer the services of brokers to a potential investor or electronically provides a means to automatically direct a request to a previously used or assigned broker. The system can directly electronically offer brokerage services, or it can electronically place a notice of intended trading allowing brokers to directly or indirectly solicit potential clients.

The online securities trading system which can be used for carrying out the methods described above generally comprises a first digital computer, a second digital computer, and an electronic communication system functionally connecting the first digital computer with the second digital computer. The first digital computer is typically on the broker end, and the second digital computer is typically on the client end. An application is present on the first digital computer for establishing and maintaining an online trading account for the client. The application accommodates purchases and cash-out value tracking for at least one client portfolio where the portfolio comprises at least one client-specified basket. The at least one client-specified basket comprises client-proportioned percentages of at least a first electronically tradable investible and a second electronically tradable investible, and the basket is established in an initial virtual or real investment amount specified by the client. A virtual investment can be used for game purposes, for example. An application on the second digital computer, generally the client's computer, is for electronically selecting at least first and second electronically tradable investibles for which data sets of historical unit values are available from an electronic database. The application electronically provides for downloading the data sets and forming a virtual basket comprising weighted percentages of the first electronically tradable investible and the second electronically tradable investible. The application electronically provides for incorporating the virtual basket into a virtual portfolio and electronically transmitting data describing the virtual portfolio over the electronic communication system to the first digital computer for inclusion in the online trading account in the initial virtual or real investment amount.

Another embodiment of the invention electronically provides a graphing method. For a virtual or real investment made at a specified date and time of an allocated amount in an electronically tradable investible, optionally with a specified reapportionment strategy, there is electronic displayed an algorithmically updated cash-out value graph over time. An electronically tradable investible for which a data set of historical unit trading prices is available from an electronic database accessible by the digital computer is selected by use of a digital computer and program accessing a digital information highway. The data set in the electronic database is electronically downloaded and/or accessed by the digital computer program. A numerical value for the allocated cash amount to be invested in the electronically tradable investible is provided for use by the digital computer program. The allocated cash amount can be the system default unitary allocation. An investment start date and time for the virtual or real investment in the electronically tradable investible are provided for use by the digital computer. The computer program calculates the number of investment units in the electronically traded investible by dividing the numerical value of the allocated total amount to be invested by the unit price of the tradable security at the investment start date and time. On an electronic display associated with the digital computer, the computer program electronically displays a graph of virtual or real investment cash-out values as a function of date and time, over time, for the virtual or real investment. The cash-out value graph backward and (data permitting) forward from the investment start date and time over the date range is generated algorithmically by the digital computer program based on the calculated number of investment units, the investment start date and time, the apportionment strategy if adopted, and the historical unit trading prices accessed by the digital computer from the electronic database.

Another embodiment of the invention electronically provides a system for displaying a cash-out value graph over a user-specified time for a virtual cash investment of an allocated amount at a specified time and date in an electronically tradable investible. The system comprises a digital computer, historical trade-price data, an electronic display, graphing software, interactive input software, and at least one user input device. The historical trade-price data is for the electronically tradable investible against time. It is stored in a database electronically accessible by the digital computer. The electronic display and graphing software are operatively associated with the digital computer. The graphing software is for processing the database for the period specified and electronically displaying a virtual investment cash-out value graph over this time for the virtual investment made at a specific time and date in the electronically tradable investible. The interactive input software is operatively associated with the digital computer. It is for accepting an initial or a revised virtual or real investment cash allocation and an initial or a revised specific starting date and time for the cash-out value graph as well as an initial or revised investment period. The at least one user input device is for inputting an initial or revised virtual investment cash allocation and an initial or a revised virtual investment date for the cash-out value graph and an initial or revised investment period.

A method for electronically displaying value changes of an initial virtual or real investment in an electronically tradable investible can be carried out on the just-described system. The cash value against time data is electronically received for the at least one electronically tradable investible from a database. Inputs establishing the initial or revised starting cash value for the cash value graph are received. The cash value against time data, the initial or revised starting cash value, and the initial or revised investment starting date are electronically processed with the graphing software for an initial or revised investment period. The cash value graph of the changes in cash value over time over the desired period based on the initial or revised starting cash investment is displayed on the electronic display.

Another embodiment of the invention electronically provides a method for displaying a graph representative of performance over a defined time period of a collection of electronically tradable investibles in a virtual basket comprised of apportioned/weighted percentage holdings of electronically tradable investibles presented as percentage proportions of the total virtual basket, optionally along with a reapportionment strategy based on time period or event triggers. The basket is comprised of at least a first electronically tradable investible and a second electronically tradable investible. An initial default investment starting date for the basket is electronically provided for use by the digital computer, with a default charting time period being used to electronically display an initial chart. A first electronically tradable investible for which a data set of historical unit trade-prices is available from an electronic database accessible on a digital information highway is selected for use of the digital computer. The data set for the first electronically tradable investible is selected by use of the digital computer from the electronic database for use in calculating cash-out values for the basket. A second electronically tradable investible for which a data set of historical unit trade-prices is available from an electronic database accessible on a digital information highway is selected for use of the digital computer. The data set for the second electronically tradable investible is accessed by use of the digital computer from the electronic database for use in calculating cash-out values for the basket. Weightings for the at least the first electronically tradable investible and the second electronically tradable investible are initially equally apportioned electronically to make up the basket on the basis of percentages, and a reapportionment strategy is not employed. The sum of all electronically tradable investibles making up the basket is selected from unity, 100 percent, or an allocated cash value for the basket as of the investment starting date. A cash-out value graph is displayed on an electronic display associated with the digital computer illustrating the historical cash-out values for the total basket backward and (data permitting) forward from an investment starting date as well as the relative apportionment of each component of the basket. The initial default investment starting date, apportionments, charting time ranges and total basket values, and reapportionment strategies can be easily modified for recalculation and electronic display updating by the computer. For example, the apportionment strategy might be to readopt the initial apportionment at the start of every month.

Another embodiment of the invention electronically provides a system for electronically displaying a cash value graph representative of performance over time of a virtual or real investment in a basket comprised of weighted amounts of at least a first electronically tradable investible and a second electronically tradable investible. The system comprises a digital computer, an electronic display, a communication system, an electronic database, an application, graphing software, interactive software, and at least one user input device. The electronic display is operatively associated with the digital computer. The communication system is operatively associated with the digital computer and is connected to a digital information highway. The electronic database contains data sets of historical unit values for at least a first electronically tradable investible and a second electronically tradable investible accessible from the digital computer via the communication system. The application is on the digital computer and is for electronically retrieving the data sets and mathematically electronically forming a virtual basket comprised of weighted percentages of the first electronically tradable investible and the second electronically tradable investible. The graphing software is operatively associated with the digital computer and is for electronically displaying a cash value graph of the cash value of the virtual basket against time on the electronic display. The interactive software is operatively associated with the digital computer and is for accepting a cash value and a starting date for the virtual basket and optionally changes in starting cash value, apportionments, charting periods, and reapportionment strategies. The at least one user input device is for providing inputs for acceptance by the interactive software.

The just-described system can be used in a method for forming a virtual basket comprising a first electronically tradable investible and a second electronically tradable investible. In the method, the data sets for the investibles are electronically accessed. Inputs are received establishing the initial or a revised starting cash value and an initial or a revised investment starting date for the cash value graph. The data sets, the initial or revised starting cash value, and the initial or revised investment starting date and optional reapportionment strategies are electronically processed with the graphing software over a specified or revised time period. The cash-out value graph for the virtual basket over time based on the initial or revised virtual or real investment starting cash value and initial or revised investment starting date and optionally a virtual or real reapportionment strategy is displayed on the electronic display.

In another embodiment of the invention, a method is electronically provided for non-automatically reallocating weighted cash-out values to a first electronically tradable investible and a second electronically tradable investible in a virtual basket comprising at least a first and a second electronically tradable investible wherein the basket has an overall cash-out value. A unity diagram having an area representing 100 percent of the overall cash-out value of the basket is displayed on a electronic display operatively associated with a digital computer. At least one divider element dividing the area into at least two subareas proportionally representing weighted cash values for the first electronically tradable investible and the second electronically tradable investible is electronically displayed on the unity diagram. The size of one of the subareas is adjusted by use of a digital computer with a user input device coupled to the digital computer. The size of the at least one other subarea is responsively automatically electronically adjusted with a self-executing software application residing on the digital computer to preserve a unity value for the summed areas.

The unitary diagram represents an apportionment of value at a point in time described as the investment start date. This apportionment changes with time as the individual investible values fluctuate or automatic reapportioning strategies are implemented, and the user can view a unity diagram displaying relative apportionment at any time other than the initial investment time or even command an animated evolution over time of the changes in relative value of a basket's investibles. Reapportionment of a basket can be associated with an investment date, and reapportionments can be performed within a charted investment period. The reapportionment strategy execution can be automatically triggered based on trigger events which can be calendar based. Reapportionment strategies can be developed from standard tools offered by the software incorporating common standardized patterns and triggers. For example, period patterns can be as simple as monthly reapportioning to the initial investment apportionment ratios. Trigger events can be set to require rebalancing when any investible falls below a certain percentage of its initial value. External trigger events can be incorporated into more complex strategies such as reaching a predetermined rise or fall of a key indicator, the database of which is available for monitoring, a change in an index, or any event that is easily and continuously accessible in a public database and that can be set to trigger execution of a reapportionment strategy. An example of an external event triggering a reapportionment strategy can be selling certain investibles in a basket and rebalancing the remainder of the basket when a market index falls or rises at a certain rate. Many reapportionment strategies can be developed, and databases used as potential trigger events can be offered by the software or purchased in the store as reapportionment tools developed by others such as moving averages. Several predetermined strategies for reapportioning can be offered with frequencies, levels, and trigger events being user selected.

In a further embodiment of the invention, a method is electronically provided for allocating apportioned starting cash values for a first electronically tradable investible and a second electronically tradable investible making up a virtual basket. The method requires a digital computer, an electronic display, an electronic database, an application, cash value graphing software, and interactive software. The electronic display is operatively associated with the digital computer. The electronic database contains data sets of historical unit values for at least a first electronically tradable investible and a second electronically tradable investible. An application resides on the digital computer for electronically retrieving the data sets and mathematically electronically forming a virtual basket comprising weighted percentages of the first electronically tradable investible and the second electronically tradable investible. The cash value graphing software is operatively associated with the digital computer for displaying on the electronic display a cash value graph for the virtual basket against time. Interactive software operatively associated with the digital computer for accepting an initial or revised starting cash value and an initial or revised investment starting date for the cash value graph is provided. Interactive software is operatively associated with the digital computer for displaying on the electronic display a unity diagram representing 100 percent of the starting cash value of the basket. Interactive software is operatively associated with the digital computer for displaying on the unity diagram at least one movable divider element dividing the area into subareas proportionally representing apportioned starting cash values for the first electronically tradable investible and the second electronically tradable investible. Interactive software is provided for moving the divider element or otherwise adjusting the apportionment and for inputting an initial or a revised starting cash value and an initial or a revised investment starting date for the basket. The adjustment can be done directly by the user by use of the digital computer or by an automatic reapportioning strategy developed based on the occurrence of a triggering event and implemented by the software. The system electronically receives a user command or electronically detects the occurrence of a predetermined triggering event and produces an automatic command to reallocate the apportioned starting cash values between the first electronically tradable investible and the second electronically tradable investible according to the predetermined strategy. The cash value graph is electronically recalculated in view of the reallocated cash values, and the recalculated cash value graph is electronically displayed on the display device.

Another embodiment of the invention provides a method for electronically displaying relative historical cash-out value differences and trends in virtual cash-out values between a first virtual or real basket comprising at least one first electronically tradable investible and a virtual or real second virtual basket comprising at least one second electronically tradable investible. A first virtual or real basket comprising at least one first electronically tradable investible for which a first data set of historical cash values is available from an electronic database is established. A second virtual or real basket comprising at least one second electronically tradable investible for which a second data set of historical cash values is available from an electronic database is established. The first data set and the second data set are accessed by use of the digital computer from the electronic database. Equal initial virtual or real investment starting cash values for the first virtual or real basket and the second virtual or real basket are established. A virtual or real investment starting date for the initial virtual or real starting cash value is selected by use of the digital computer. A cash value graph of the difference in change between the first virtual or real basket cash value and change in the second virtual or real basket cash value, said difference being expressed as a percentage change against time forward and/or backward from the virtual or real investment starting date, is calculated by the digital computer and is displayed on an electronic display associated with the digital computer.

Another embodiment of the invention provides a system for electronically displaying relative price differences and trends in value between a first virtual basket comprising at least one first electronically tradable investible and a second virtual basket comprising at least one second electronically tradable investible. The system comprises a digital computer, an electronic display, a communication system, an electronic database, an application, interactive software, and at least one user input device. The electronic display and the communication system are operatively associated with the digital computer. The electronic database is accessible by the digital computer via the communication system. It contains digital data sets of historical unit values for the first electronically tradable investible and the second electronically tradable investible. The application is on the digital computer. It is for accessing the data sets and displaying on the electronic display a graph of a difference in change between a first virtual or real investment cash value and change in a second virtual or real investment cash value, said difference expressed as a percentage change against time. The interactive software is operatively associated with the digital computer for accepting an initial or revised virtual or real investment starting date for the cash value graph. The at least one user input device is for inputting the initial or a revised starting date, said first basket and said second basket being of the same virtual or real investment starting cash value as that of the initial or revised investment starting date.

Another embodiment of the invention provides a method for electronically displaying relative price differences and trends in value between a first virtual basket and a second virtual basket using the just-described system. The data sets are electronically received by the digital computer. An input establishing the initial or the revised investment starting date for the graph is received by the digital computer. The data sets and the investment starting date are processed with the graphing software. The graph of the difference in change between the value of the first virtual basket and the second virtual basket is electronically displayed.

Another embodiment of the invention provides an electronic gaming method. In the method, an online game forum is electronically provided for a virtual basket investment competition where each basket is comprised of electronically traded investibles. Types of game formats, historical time periods for fast games or future-based games, number of players and player teaming, genres, and rules are electronically posted on the internet forum for conducting the competition, including the start date and the ending terms. Downloadable software is provided for forming the virtual investment baskets. Virtual investment baskets are received online from competitors for entry into the competition prior to the start date. The competition is started. Performance graphs are made available online for portfolios or baskets entered into the competition. The competition ends when the ending terms are met, and a winner of the competition is electronically posted on the game forum.

Another embodiment of the invention electronically provides, by use of a digital computer, an electronic display, a communication system, an electronic database, an application, interactive software, and at least one user input device, a method comprising (a) electronically opening a virtual Ideas Vault, (b) creating a virtual investment portfolio in the vault, (c) allocating a virtual investment amount to the portfolio, (d) creating a virtual basket (folder) in the portfolio, (e) allocating part of the investment amount to the basket, (f) selecting a virtual investible for the basket, (g) repeating step (f) with different investibles to populate the basket, (h) apportioning, by use the digital computer, the basket cash allocation between the investibles on a percentage basis, (h1) optionally developing a reapportionment strategy for the basket based on the occurrence of a triggering event, (i) repeating steps (d)-(h) to form different baskets within the portfolio if desired, (j) reallocating cash between different baskets if desired, (k) moving the portfolio to a virtual Serious Stuff Vault, (l) selecting a real-world broker, (m) executing purchase in reality of the portfolio, (n) broker electronically moving a record of executed portfolio to user's Action Vault, and (o) user being able to make modifications by repeating steps (k)-(n) with an indication to the broker that the modified portfolio is to be a replacement.

### BRIEF DESCRIPTION OF THE DRAWINGS

FIG. 1 illustrates a screen titled “MiETF Vaults” showing hot buttons for the various vaults.

FIG. 2 illustrates a screen titled “MiETF Vaults” requesting a system passcode used in the event a passcode to enter the vault is forgotten.

FIG. 3 illustrates a screen titled “MiETF Vaults” for making first-time selections to name a vault, set an associated color for the vault, and to set a passcode for the vault.

FIG. 4 illustrates a screen titled “MiETF Samples Vault” showing a preferred key code entry for opening this vault, with the same method being applicable for other vaults already set up.

FIG. 5 illustrates a screen titled “MiETF Samples Vault” showing the portfolios in the vault after making a selection in FIG. 4.

FIG. 6 illustrates a screen titled “MiETF Examples Portfolio” showing a folder in the portfolio containing symbolic pages representing the baskets or MiETF assemblages of stocks after making a selection in FIG. 5.

FIG. 7 illustrates a screen titled “MiETF Examples Portfolio” showing a folder in the portfolio containing the baskets or MiETF assemblages of stocks after making a selection in FIG. 6.

FIG. 8 illustrates a screen titled “MiETF Samples Vault” setting forth steps for initiating a System Recovery in the event of a lost password.

FIG. 9 illustrates a screen electronic display titled “MiETF Historical Performance” showing the graphical performance of a basket or MiETF assemblage of stocks against other graphs after making a selection in FIG. 6.

FIG. 10 illustrates a screen electronic display titled “MiETF Components” showing the components of a basket or MiEFT assemblage of stocks after making a selection shown in FIG. 6.

FIG. 11 illustrates a screen electronic display titled “MiETF Stock Sectors” showing hot buttons for accessing listings of individual stocks in a stock sector after making a selection in FIG. 10.

FIG. 12 illustrates a screen electronic display titled “MiETF Healthcare Component” showing hot buttons for accessing data for stocks in a section after making a selection in FIG. 11.

FIG. 13 illustrates a screen electronic display titled “MiETF Merck & Co Inc.” showing a stock graph according to an embodiment of the invention after making a selection in FIG. 12.

FIG. 14 illustrates a screen electronic display titled “MiETF Merck & Co Inc.” showing a stock graph according to an embodiment of the invention after making a selection in FIG. 13.

FIG. 15 illustrates a screen electronic display titled “MiETF Merck & Co Inc.” showing a stock graph as in FIG. 14 after adjustment according to an embodiment of the invention.

FIG. 16 illustrates a screen electronic display titled “MiETF Ideas Vault” showing the contents of the Ideas Vault according to an embodiment of the invention.

FIG. 17 illustrates the effect of opening a hot area of FIG. 1.

FIG. 18 illustrates the effect of opening a hot area of FIG. 17.

FIG. 19 illustrates the effect of opening a hot area of FIG. 1.

FIG. 20 illustrates the effect of opening a hot area of FIG. 19.

FIG. 21 illustrates the effect of opening a hot area of FIG. 20.

FIG. 22 illustrates the effect of opening a hot area of FIG. 1.

FIG. 23 is a flow chart illustrating certain features of an embodiment of the invention.

FIG. 24 schematically illustrates certain features of a system according to an embodiment of the invention.

FIG. 25 illustrates a slide giving additional details of one of the features of FIG. 1.

FIG. 26 illustrates the effect of opening a hot area of FIG. 25.

FIG. 27 is a flow chart illustrating certain features of an embodiment of the invention.

FIG. 28 is a graph illustrating certain features of an embodiment of the invention.

FIG. 29 is a graph illustrating certain features of an embodiment of the invention.

FIG. 30 schematically illustrates certain features of a system according to an embodiment of the invention.

FIG. 31 is a chart illustrating certain method features of an embodiment of the invention.

FIG. 32 is a flow chart illustrating certain features of a method of the invention.

FIG. 33 is a flow chart illustrating certain features of a method of the invention.

FIG. 34 is a flow chart illustrating certain features of a method of the invention.

FIG. 35 schematically illustrates certain aspects of gaming features according to embodiments of the invention.

FIG. 36 is a flow chart illustrating certain features of a method of the invention.

FIG. 37 schematically illustrates certain features of a feature according to an embodiment of the invention.

FIG. 38 illustrates the effect of opening a hot area of FIG. 37.

### BEST MODE FOR CARRYING OUT THE INVENTION

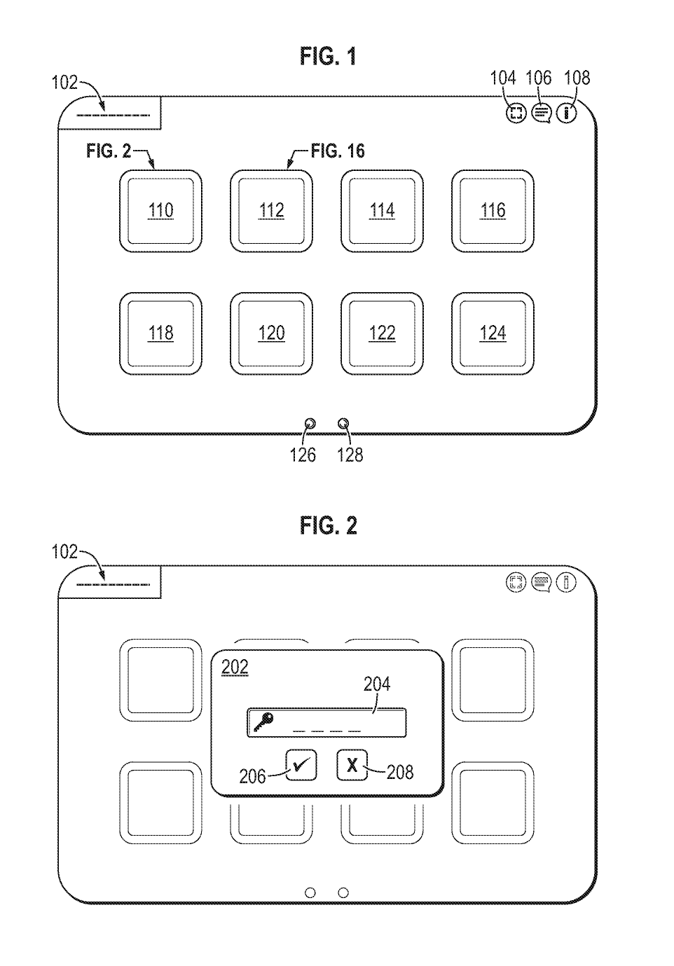

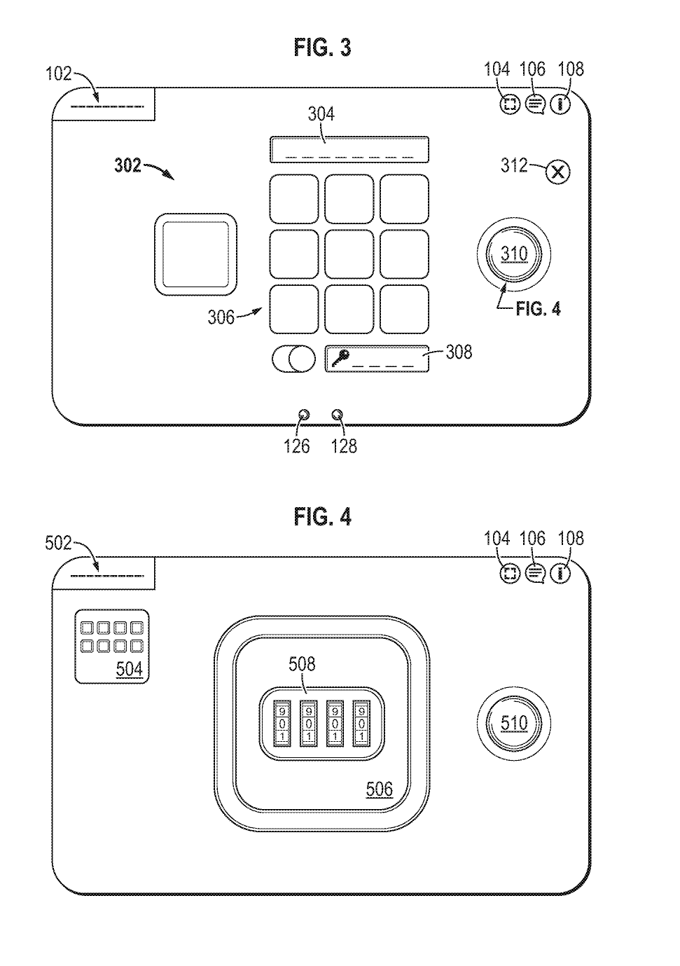

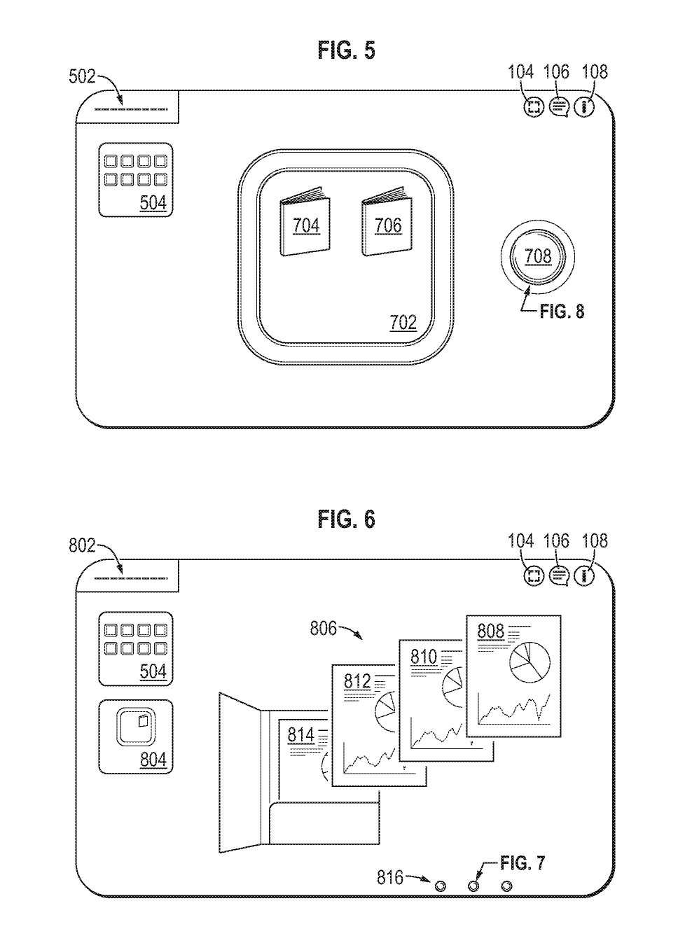

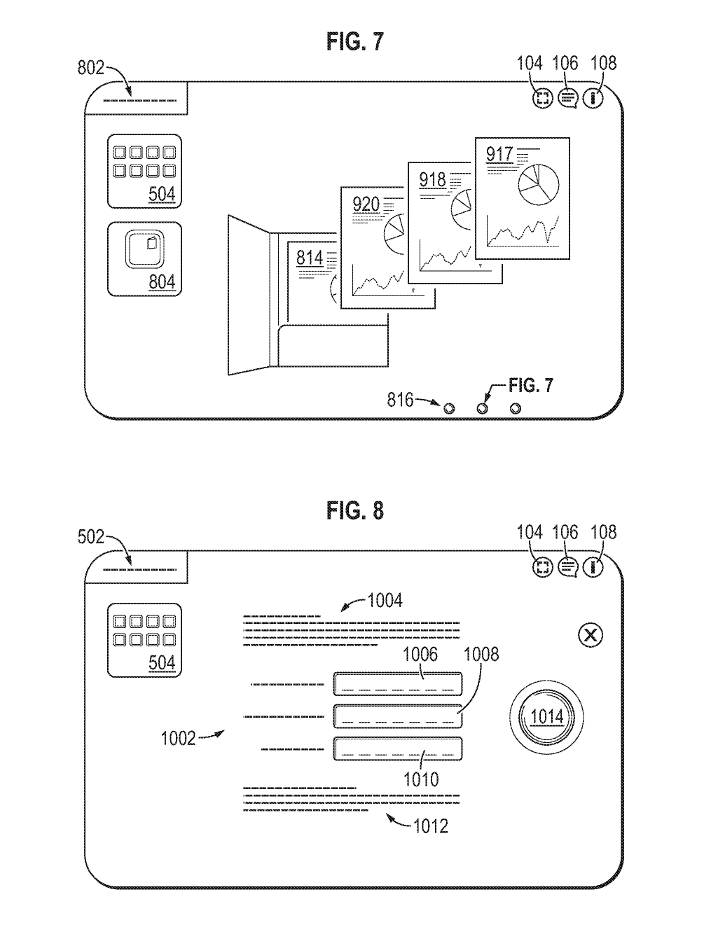

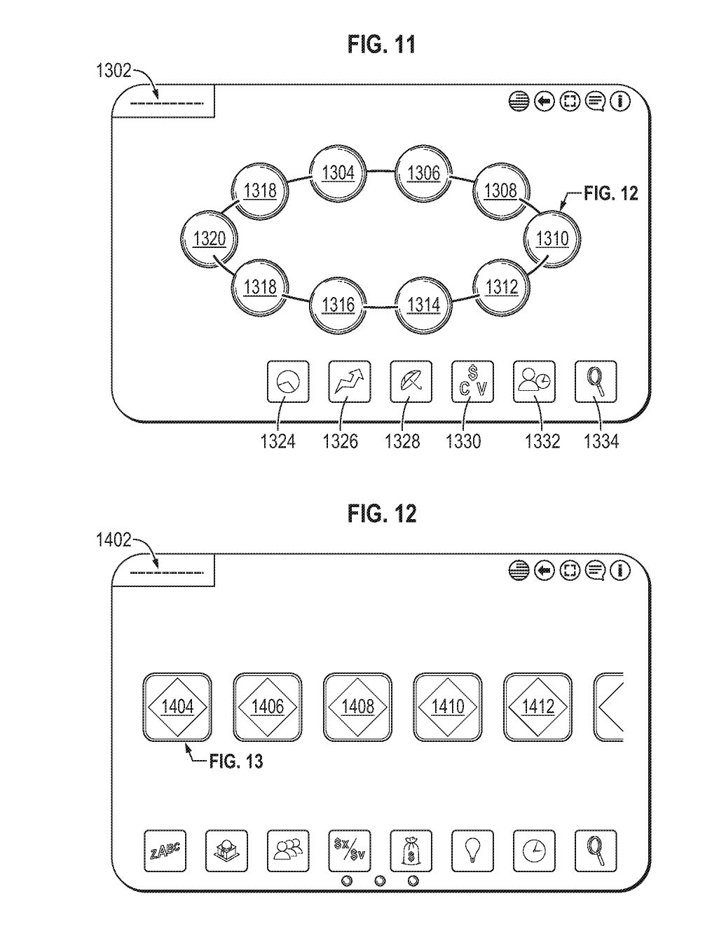

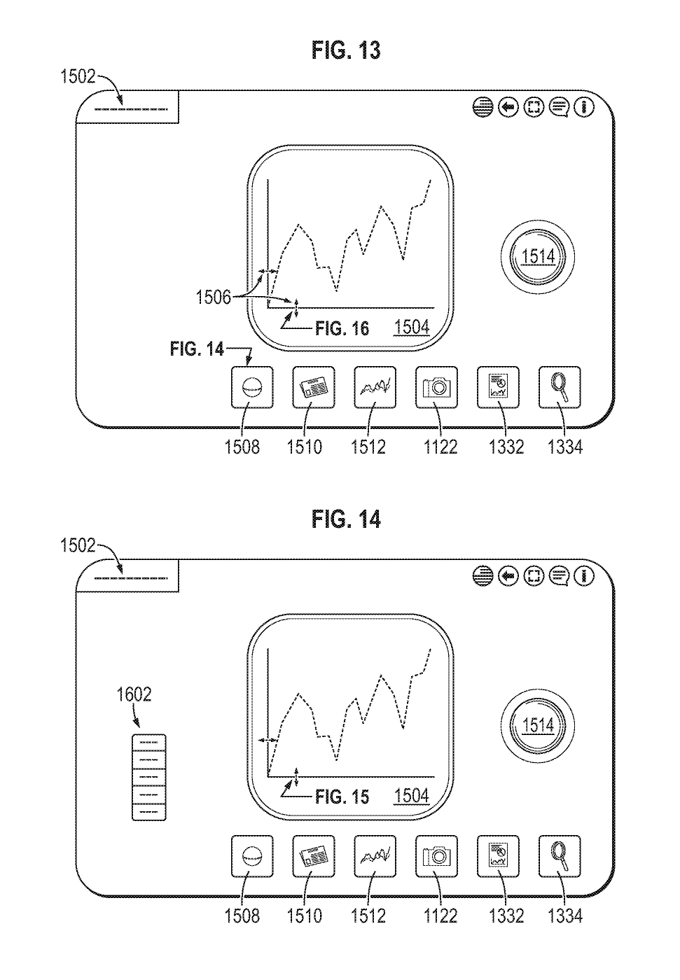

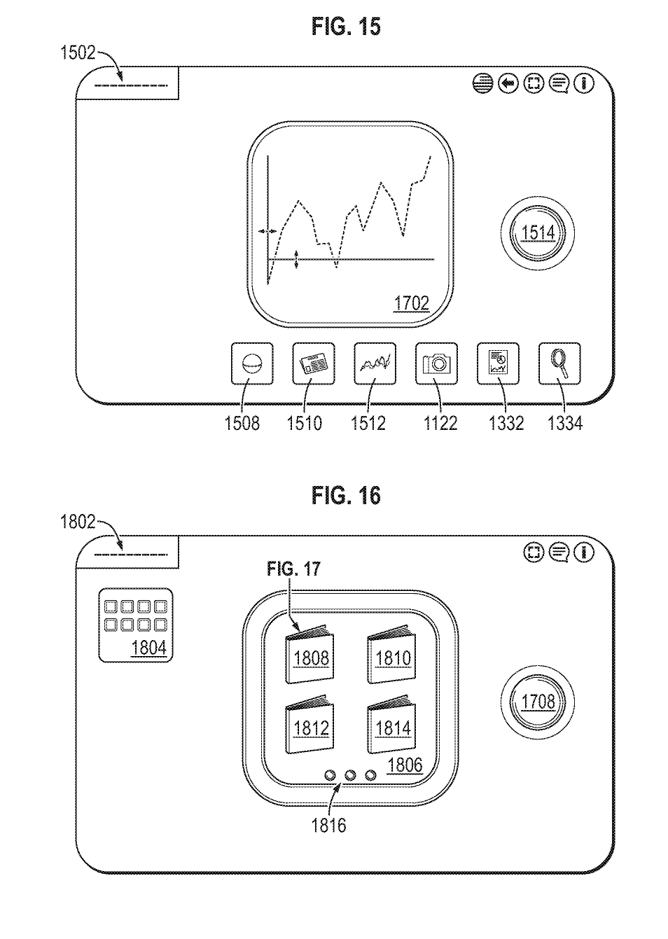

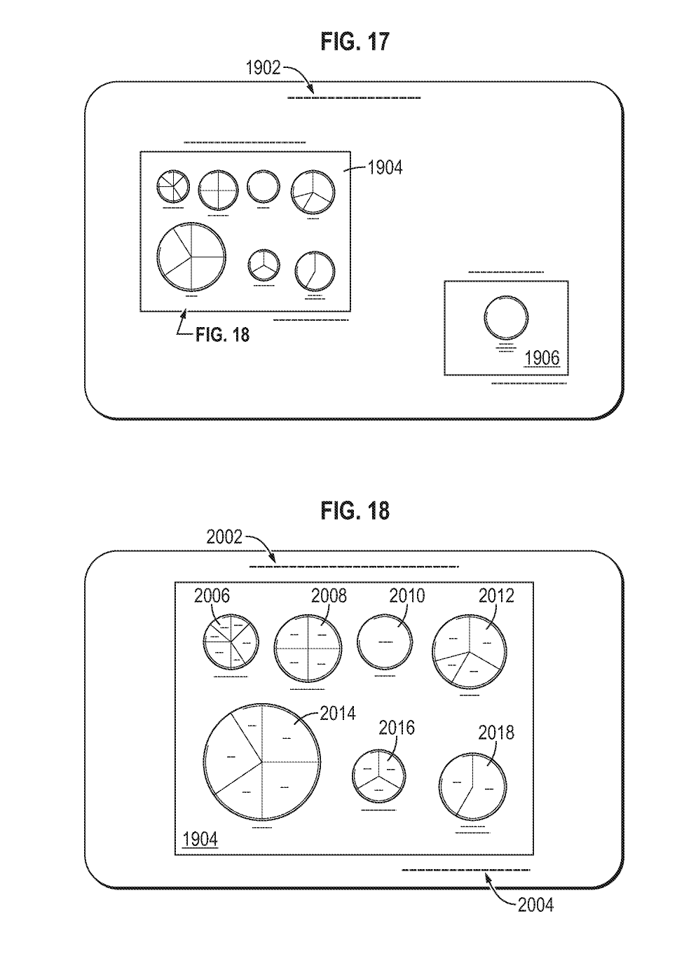

In several of the embodiments illustrated generally in FIGS. 1-24, the general approach is to create the investment portfolio with a name and a “value” default in a unity-type value—say $100,000, then create the baskets.

The baskets are preferably contained within portfolios to keep things organized. More preferably, vaults contain portfolios, the portfolios contain the baskets, and the baskets contain the investibles. Further, the Baskets can have automatic reapportionment strategies associated with them.

When selecting investibles, the program preferably electronically provides access/links to general research data as electronically provided by any online system dealing with investibles. In a preferred embodiment, such facilities are electronically provided as part of the inventive system, even though this is not specifically an inventive step when viewed alone.

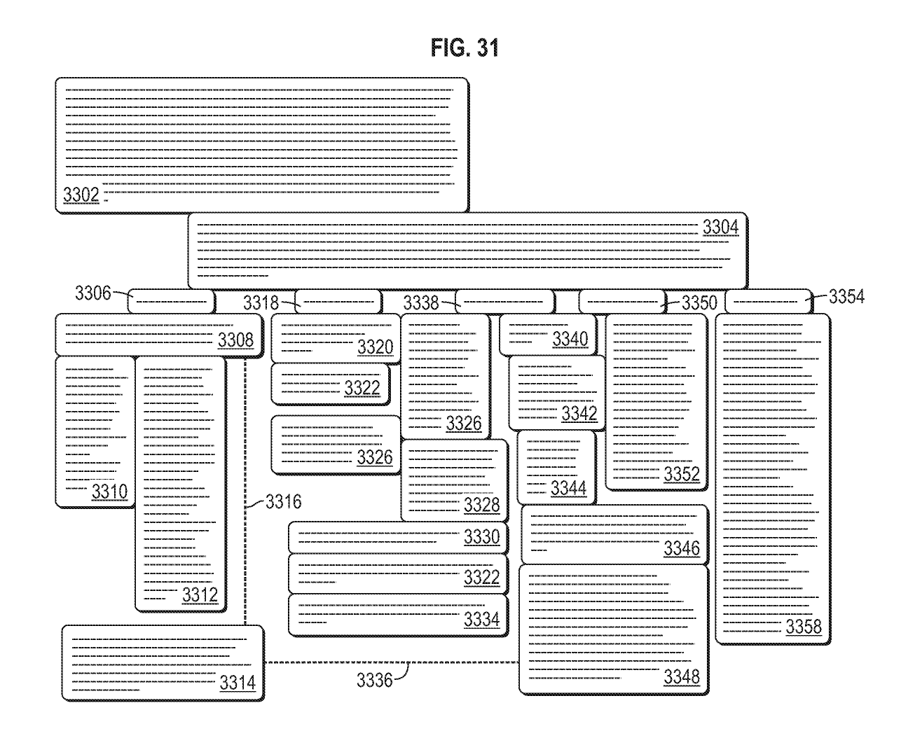

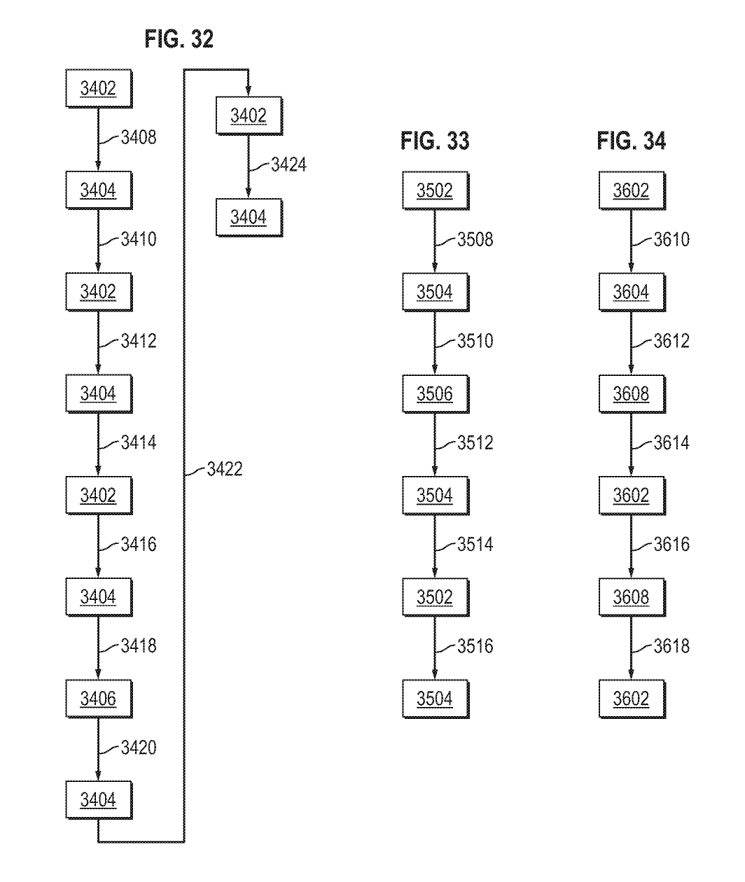

One embodiment of the invention electronically provides an online store (See FIG. 31) where a shopper can purchase virtual investment formulations. The store offers an inventory of virtual investment baskets originating from different authors. The full basket descriptions, which include the individual tradable item names and relative weightings and optional reweighting strategies, are not visible or disclosed prior to purchase, but rather are advertised for purchase by electronic display of their characteristics and historical performance charts in the online store. The historical performance charts electronically presented to potential purchasers by the store are user-amendable, tailored performance charts for each unique offering described as a “basket” in the online store. The baskets are similar to ETFs, except that the actual investibles (meaning securities or currency) in the virtual formulation have to be acquired by the purchaser as discrete weighted components of the formulated basket in a separate step if the basket is to be transformed into a real investment because what the store typically electronically sells are virtual formulations rather than the singular tradable investments themselves. The baskets are privately originated investment formulations and are not sold on exchanges. However, a brokerage can sell the baskets and the actual investibles directly if the store offers such brokerage house services. The baskets each comprise a number of units of each of at least a first electronically traded investible and a second electronically traded investible, with the specified relative weightings at the specific point in time determining the number of units of each. The relative weightings of the investibles on a dollar basis fluctuate over time, and the basket can be offered by the store with a reapportionment strategy.

In a preferred embodiment of the invention, store electronic access causes to be displayed on the user's device a historical performance chart of a basket and a means for the user to electronically purchase a detailed description of the formulation of the basket. The basket's historical performance chart electronic display can be adapted for more specific viewing requirements by the potential purchaser. A complete description of the basket formulation is electronically transmitted to the user's device upon purchase of the complete description by the user for electronic access and/or downloading on a user's computer at any time, indefinitely.

The store can be electronically linked to trading institutions which complete the real-world purchase transactions represented by the compositions of the baskets for users. If desired, the trading institution offers selected baskets from the store inventory, in effect offering a selection of private ETFs. The store as displayed on the user's computer preferably has password-protected electronic access or sections since it contains previously purchased items.

To guard against spurious basket formulations being offered for sale at the online store, a basket formulation is preferably only electronically offered for sale after its composition has actually been meaningfully purchased or entered into a game by its author in a method using a software program obtained from the store. Store software is provided for users to create baskets. The baskets are preferably characterized by a tagging system, both user specified and also automatically generated to prevent mischaracterizing by users that allows the store inventory to be searchable by authors, genres, key words, tags, or any other descriptors associated with baskets or authors by potential purchasers and basket descriptions. Pricing strategies and guides are by predetermined criteria. The predetermined criteria is selected, for example, from the group consisting of the number of previous sales, the author's length of time actively participating, organizational status, performance history, gaming success, or other criteria.

As an option, a virtual basket is automatically electronically offered for sale in the store after its composition has actually been purchased or gamed by its author unless the author pays a fee electronically to remove the basket from the store offerings in order to keep it private.

Preferably, an inventory of descriptions of basket formulations is permanently retained by the store, and the descriptions of the basket formulations previously paid for can be subsequently electronically accessed by the user without further payment. The basket descriptions comprise store property, and the store makes electronic payments to the authors of basket descriptions which are electronically purchased by third parties.

The downloadable virtual baskets are electronically provided in editable form. When being viewed by potential buyers, there is displayed on the user's screen device a performance chart of a basket being offered for sale together with an investment date at the time selected by the author, which is used to calculate the performance chart for initial electronic display on the store site. Amending the investment date changes the relative weightings for the electronically traded investibles over time. The relative number of units of the investibles as of the investment date can be used to calculate the performance chart, or the relative number of units reweighted as of the present date can be used to calculate the performance chart, and the performance chart can be editable for a changeable investment date to vary the basket composition. Any reapportionment strategy associated with the basket can be automatically and consistently implemented based on a new initial investment date.

For payment, the store electronically bills using a credit card or debit card or automatically using a previously entered payment method or stored credit from previous sales. Credits can be electronically provided to the accounts of the authors of basket descriptions which are purchased by third parties, and payments can be electronically provided to authors upon electronic redemption of credits, preferably upon redemption of a predetermined minimum number of credits. Credits can also be used to make electronic purchases in the store.

The store can sell electronic access to data using various offerings such as time ranges, data densities, quantity, download limits, updating streaming, and similar data-related services.

The store can sell advertising for baskets or otherwise promote baskets or authors of baskets on its website. The store can also offer informational paper goods or informational subscription services for sale.

The store can promote and advertise trading institutions, investment offers, and the like. It can be a platform to activate paid links. It can act as a gateway to TV and radio presentations. Promotions can be made as directly related activities such as purchasing an investment portfolio created using the program or indirectly as a means of promoting any service. General advertising of unrelated services and goods is also possible.

The store software used for creating baskets electronically provides a user having a digital computer and electronic access to a digital information highway the means for providing for use by the digital computer an investment starting date for the basket; the means for selecting by use of a digital computer a first electronically tradable investible for which a data set of historical unit trade-prices is available from an electronic database accessible on a digital information highway; the means for accessing the data set for the first electronically tradable investible on the digital computer from the electronic database for use in calculating performance for the basket; the means for selecting by use of a digital computer a second electronically tradable investible for which a data set of historical unit trade-prices is available from an electronic database accessible on a digital information highway; the means for accessing the data set for the second electronically tradable investible on the digital computer from the electronic database for use in calculating performance for the basket; the means for apportioning weightings for the at least the first electronically tradable investible and the second electronically tradable investible to make up the basket on the basis of percentages, with the sum of all electronically tradable investibles plus cash making up the basket being selected from unity, 100 percent, or an allocated cash value for the basket as of the investment starting date; and the means for displaying on an electronic display associated with the digital computer a cash-out value graph illustrating the historical cash-out value for the total basket backward and (data permitting) forward from the investment starting date and the relative apportionment of each component of the basket at any point in time. Preferably, the means for implementing a strategy for future automatic reapportioning is also electronically provided. The cash-out value graph is preferably further based on a charting range for the graph. The charting range is preferably editable.

In a preferred embodiment, the software requires that the sum of all electronically tradable investibles making up the basket plus cash, if present, is 100 percent as of the investment starting date. In a further preferred embodiment, the software electronically provides that the cash-out value graph visually stacks apportioned weightings for each of the electronically tradable investibles separately over time. In another embodiment, the software electronically provides that the cash-out value graph separately color-codes an apportionment for each component of the basket. In another embodiment, the software electronically accepts from the user either a virtual starting date or an actual starting date, with this date not necessarily coinciding with the chart range starting point. In another embodiment, the software electronically accepts from the user either an initial starting date or a revised starting date. In another embodiment, the allocated cash value for the basket is virtual or real, and the investment date is an actual investment starting date.

The digital information highway comprises the World Wide Web or any other digital means to electronically access publicly available electronic databases. The software preferably electronically provides a user having a digital computer and electronic access to a digital information highway the means for converting the graph from percentage value to cash value by use of the digital computer.

The store forms a sort of cooperative for the baskets in the form of a remotely electronically accessible program or Internet Web page sponsored by a host site for posting user-defined virtual investment basket formulations and host-site-generated and presented performance information which can be viewer-tailored for analysis or evaluation prior to purchase. As noted before, the baskets have a composition comprising weighted amounts of at least a first electronically tradable investible and a second electronically tradable investible as of a specified date, preferably with an associated reapportionment strategy. To promote baskets for sale, they can be catalogued by the user tags and descriptions along with automatically computer-generated characterizations which are searchable by users browsing the electronic store. The library of offerings can be displayed as index charts appearing like the covers of books, with the ability to more closely explore an item of interest by clicking on a displayed item. Following this, a detailed description and amendable performance chart for analyzing the basket performance information can appear as an image on the user's electronic display along with a hot area to receive a purchase command for electronically transmittal to the host site. The optional formulation and rebalancing strategy of the basket offered for sale is preferably fixed, but the charted historical performance of such a formulation is dependent on the starting investment date and the investment period, both of which can be set by the purchaser reviewing the basket's historical performance. On an electronic display associated with the user's digital computer, the store electronically provides an image of a default cash value graph of the value of the basket against time as well as hot areas to adjust the investment starting date and investment period for the basket. That permits the user to test the basket historically against various market conditions such as inflationary periods or market crashes. Computer-generated details pertaining to the character of the investibles can be included in the descriptors to ensure the offering is suitable for a potential purchaser's area of interest.

### See FIG. 31

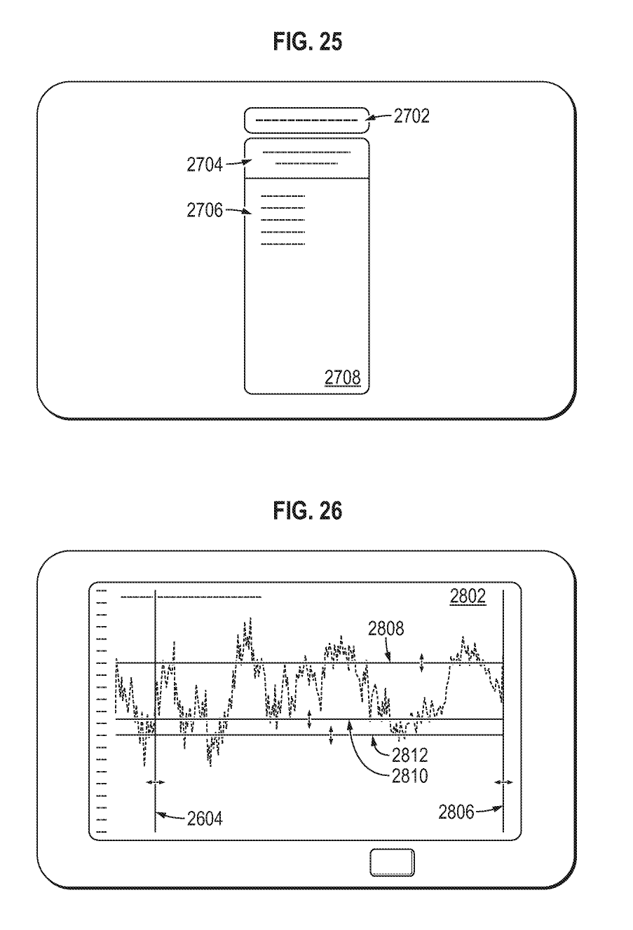

The store can also electronically provide for purchase descriptions of arbitrage pairings of baskets. See FIGS. 25, 26 and 29. This service is electronically provided in the form of a remotely electronically accessible or downloadable program or Internet Web page sponsored by the host site for posting user-defined performance information for virtual investment basket pairings. Each virtual basket pairing includes a first virtual basket comprising at least one first electronically tradable investible and a second virtual basket comprising at least one second electronically tradable investible. The remotely electronically accessible program or Internet Web page is presented via the Internet or other electronic information highway as an image on the user's electronic display of a default cash value graph of the difference in change in the first virtual basket's starting unitary cash value and the change in the second virtual basket's starting unitary cash value. The difference is expressed as a percentage change. The image preferably further includes a hot area to electronically transmit an electronic access command to purchase a description of the first virtual basket and the second virtual basket formulations. Hot areas are also preferably electronically provided for receiving commands to adjust the starting cash value of each basket and the investment starting date for each basket. This permits a user to evaluate the relative performance of the baskets historically against various market conditions such as inflationary periods or market crashes.

If desired, the pairings can be electronically provided by a remotely electronically accessible or downloadable program or Internet Web page and the user electronic display can be operatively connected to a digital computer running software controlling the appearance of the display. The first virtual basket can represent a virtual basket for virtual sale, and the second virtual basket can represent a virtual basket for virtual purchase.

Another embodiment of the invention electronically provides an organizer system in the form of multiple virtual electronic workspaces. See FIG. 31. The system comprises a computer program operating in conjunction with a digital computer system to electronically provide a visual interface displaying screen icons which locate hot areas for launching the virtual electronic workspaces. One icon is electronically provided for each hot area, and one hot area is electronically provided for each virtual electronic workspace. Each virtual electronic workspace is preferably password protected and facilitates carrying out specific definable work functions and storage. The virtual electronic workspaces are used for different purposes. Opening a virtual electronic workspace by virtual unlocking using a password permits a user to electronically access directories containing data and formulations utilised by the core applications of the virtual electronic workspace to calculate and electronically display performance graphs on the user's visual interface for virtual investment formulations. Each virtual investment formulation is comprised of apportioned/weighted percentage holdings of electronically tradable investibles including at least a first electronically tradable investible and a second electronically tradable investible, preferably together with reapportionment strategies.

In one embodiment of the invention, the visual interface electronic display has an icon identifying electronic access to a password-protected “Store” virtual electronic workspace. The Store virtual electronic workspace comprises a first “Store” subdirectory which electronically provides a electronic display containing hot areas for accessing performance graphs for baskets at a third-party website, a “Purchased Baskets” subdirectory which electronically provides on the electronic display hot areas for accessing graphs for previously electronically purchased baskets from the third-party website, and a “For Sale” subdirectory which electronically provides on the electronic display a listing of royalty-generating baskets authored by the user and being electronically offered for sale on the third-party website.

Preferably, the Store subdirectory further contains launch buttons to launch applications for selectively searching the performance graphs of baskets at the third-party website.

The visual interface preferably also displays a password-protected “Ideas” virtual electronic workspace which contains subdirectories listing virtual investment portfolios comprised of at least a first electronically tradable investible. Preferably, the Ideas virtual electronic workspace further comprises subdirectories listing virtual investment baskets each comprised of weighted amounts of at least a first electronically tradable investible and a second electronically tradable investible.

The Ideas virtual electronic workspace screen electronic display preferably further lists subdirectories of virtual investment portfolios each comprised of at least one basket, with each at least one basket comprised of at least one electronically tradable investible.

The visual interface preferably further has an icon identifying electronic access to a password-protected “Serious Stuff” virtual electronic workspace which comprises subdirectories of virtual investment portfolios, at least some of which are comprised of at least one basket comprised of weighted amounts of at least a first electronically tradable investible and a second electronically tradable investible.

The visual interface preferably further has an icon identifying electronic access to a password-protected “Action” virtual electronic workspace which comprises third-party-locked subdirectories modeling real-world investment portfolios, at least some of which are comprised of at least one basket comprised of weighted amounts of at least a first electronically tradable investible and a second electronically tradable investible.

The virtual electronic workspaces are herein referred to as “vaults” when they are password protected. An icon is electronically provided for a password-protected “Store Vault” which comprises a virtual electronic workspace permitting electronic access to resources for electronically acquiring data and other authors' formulations of electronically tradable investibles. Another icon electronically provides access to a password-protected “Ideas Vault” which comprises a virtual electronic workspace for a user formulating packages of investibles. A further optional icon electronically provides access to a password-protected “Serious Stuff Vault” which includes a virtual electronic workspace functioning as an area for testing developed formulations and reapportionment strategies and for electronically transmitting descriptions to third parties for actual trading action and execution of reapportionment strategies in reality. A further icon electronically provides access to a password-protected “Action Vault” which comprises a virtual electronic workspace providing an archive of past and current real investments originating from user-created virtual formulations developed within various other virtual electronic workspaces and electronically transmitted by the program to third parties for actual acquisition. A further optional icon electronically provides access to a password-protected “Games Vault” which comprises a virtual electronic workspace providing electronic access to investment games involving user-created formulations against third parties. Formulations residing in any virtual electronic workspace can be electronically copied from any other area or vault and electronically pasted into another area other than the Action Vault or Store Vault. Formulations appearing in these vaults are controlled by the electronic host.

The Store Vault preferably provides electronic user access to performance information at a remote third-party site to baskets each comprised of weighted amounts of electronically tradable investibles and the ability to pay for and download detailed composition information for selected baskets. The Store Vault preferably further electronically provides a computer memory/storage area for storing the downloaded detailed composition information for later electronic access and the capabilities of copying and pasting the detailed information into other vaults.

The Serious Stuff Vault electronically provides the capability of accepting detailed basket information from other vaults by pasting, and electronically provides the capability of modifying and saving the modified information for later access, and of copying and pasting the detailed information into other vaults, and further of electronically transmitting the portfolio information to a third-party site with a request to execute a purchase of the composition of the basket.

The Action Vault does not have the capability of accepting detailed basket and portfolio information from other vaults through copy and paste operations. Rather, portfolio details are automatically transferred from the Serious Stuff Vault to the Action Vault, optionally via a third party, following validation of a suitable real-world purchase of the composition of the portfolio. The vault accepts an electronic lock on the basket information that relates to the make-up of the basket from the third-party site once notification of execution has been received from the third-party site.

If desired, baskets in the Action Vault can be electronically provided with a reapportionment strategy feature that can be set to trigger or prompt an automatic reweighting of the real-world counterpart of a basket in the Action Vault to its original cash-out make-up at predetermined time intervals, such intervals being set on a calendar and amendable by the user, or such reweighting being done based on value drift of relative proportions beyond user-defined limits, or as based on other user-defined criteria. Execution of the reweighting of the real-world counterpart occurs at a third party site.

In one of the electronically executed methods of the invention, the user electronically accesses the Store Vault. From the Store Vault, basket performance information is electronically accessed at the third-party site. The user electronically purchases detailed basket composition information from the third-party site. The detailed basket composition information is automatically downloaded into a purchases section of the Store Vault. The user electronically copies the detailed basket composition information, and then with or without further modification, copies or causes to be copied the detailed basket composition information into the Serious Stuff Vault.

In one embodiment, the user copies or causes to be copied the detailed basket information into the Serious Stuff Vault, with or without modification. Where the detailed basket composition information that is pasted into the Serious Stuff Vault is different from the detailed basket composition information that was copied from the Store Vault, the method can further comprise pasting the detailed basket composition information that was copied from the Store Vault into the Ideas Vault, modifying the detailed basket composition information in the Ideas Vault to form a modified basket, copying the modified basket information, and pasting the modified basket information into the Serious Stuff Vault. In the Serious Stuff Vault, the modified basket information can be included as a virtual basket in a portfolio.

Where the detailed basket information is copied in the Store Vault and pasted into the Serious Stuff Vault without modification, the method can further comprise forming a portfolio in the Serious Stuff Vault containing the unmodified basket information as a virtual basket of the portfolio.

Where the composition of the copied basket is purchased and is copied to the Action Vault as a result, an electronic lock is placed on the basket information that relates to the make-up of the basket from the third-party site.

Where the composition of the copied basket is purchased, the Store Vault further provides an electronic associated computer memory area for storing basket identity information from the Action Vault that is offered for sale at the host site. The basket identity information is received from the host of the baskets in the Action Vault that are offered for sale at the host site and populated in the area of computer memory electronically provided for storing such information.

Pricing information for the baskets is electronically transmitted to the host site, and notice of electronic payments from the sale of baskets is electronically received from the host site.

When conducted as part of a game, the method can further include accessing basket performance information at the third-party site of baskets all formed on the same date by multiple third parties as a part of the game. The method can further include providing in the Games Vault an electronic display containing hot areas for launching game applications. The method can further include providing a vault icon which launches a “Gaming” application which displays a screen having hot areas for launching game applications.

Each of the above vaults is provided with an operably associated dedicated computer electronic memory storage area and electronic access to data sets of historical unit trading prices for electronically tradable investibles. They are all provided with the ability to electronically duplicate, remove, and modify existing baskets; to electronically form virtual baskets of weighted amounts of electronically tradable investibles; to electronically adjust the weightings; to electronically graph the past performance of the baskets; to electronically form virtual portfolios containing at least one virtual basket; and to electronically save information for subsequent use. The Serious Stuff Vault electronically provides a hot button that has the capability of electronically transmitting investment portfolio information to a third-party site with a request to execute a purchase of the composition of the investment portfolio and thereby reduce the portfolio to reality. The Action Vault is reserved for automatically electronically storing records for executed real investment portfolios where the user has acquired the investibles using the Serious Stuff Vault via hot button transmission and preferably a suitable return verification of execution to the host program. Records of traded portfolios are electronically placed in the Action Vault automatically by the host software for the user to use as a performance tracking tool and as a locked portfolio description that can be electronically copied later into the Serious Stuff Vault. This copy will be electronically linked to the original portfolio so that any desired modifications to an existing real portfolio can be electronically transmitted for real-world trading accounting of the existing real investments and any trading requirements optimized to achieve the new modified portfolio formulation. In a preferred arrangement, records for the baskets contained in portfolios electronically appearing in the user's Action Vault are automatically placed in the online Store Vault for purchase by others. Portfolios electronically copied from the Action Vault and electronically pasted into the Ideas Vault are no longer linked to the Action portfolio and are considered new, independent formulations under development. The Action Vault has an electronic lock placed on the portfolio information that relates to the make-up of the executed formulations once notification of execution has been received from the third-party site. Any formulation can be deleted, and upon deletion is electronically copied to a “Deleted Items” vault. A deleted items virtual electronic workspace or password-protected vault, if password protected, can be used for archiving and for retrieving items deleted accidentally or needing later recovery. The deleted items vault can be electronically displayed in a less conspicuous manner.

One method of using the just-defined Ideas Vault system includes forming a named, empty investment portfolio, for example in the Ideas Vault, then from within this portfolio's computer storage work space forming a virtual basket of weighted amounts of electronically tradable investibles in the named portfolio, copying the thus-developed developed portfolio, and pasting the copied portfolio into the Serious Stuff Vault. See FIG. 34. Alternatively, a developed basket residing in a named portfolio in any vault can also be copied and pasted as a virtual basket into an existing portfolio, which then forms a modified portfolio including the virtual basket (or a modified form of the virtual basket) in the Serious Stuff Vault. Apportioning relative investment values between investibles in baskets, implementing an automatic strategy associated with the basket reweighting, or adjusting allocations between baskets in investment portfolios can be achieved by ascribing new monetary or percentage values of a total value, amending a system default unitary value with a default equal apportionment, or by applying reweighting strategies. By pressing a hot button ideally associated with the copy and paste function, a copy of the portfolio information can be electronically transmitted from the Serious Stuff Vault to the third-party site with an indication of interest in purchasing the composition of the portfolio.

The method can be conducted as part of a game. Preferably as a game, the method further comprises providing on the user's computer a password-protected Games Vault computer memory area and accessing portfolio performance information at the third-party site of portfolios all formed on the same date by multiple third parties as a part of the game.

Where the composition of the portfolio has been purchased, the method preferably further comprises accepting an electronic lock on the basket information that relates to the detailed make-up of the basket from the third-party site. The Store Vault preferably further provides an electronic operably associated computer memory area for storing basket identity information from the Action Vault that is offered for sale at the host site, and the method further comprises receiving basket identity information from the host of the baskets in the Action Vault that are offered for sale at the host site and populating the area of computer memory electronically provided for storing such information. Pricing information for the sale of basket information at the host site can be electronically transmitted to the host, and electronic payments or notice of the same can be received from the host site for the sale of basket information.

Another method of using the just-defined vault system comprises electronically copying a portfolio in the Action Vault, electronically pasting the copied portfolio into the Serious Stuff Vault, electronically modifying the portfolio in the Serious Stuff Vault, determining whether the modified portfolio is to replace the originally copied portfolio, and if yes, pressing the hot button and electronically transmitting the modified portfolio to a third-party site with instructions to replace the originally copied portfolio in a suitably optimized manner which minimizes trading volume to achieve the new desired formulation in real-world investibles. See FIG. 33.

At the third-party site such as a brokerage, a determination is made of the parts of the portfolio to be retained and to be replaced. The determination can be made by electronic comparison, for example. The retentions and replacements are executed. The user is notified of the execution. The portfolio is copied to the Action Vault and locked in the Action Vault to prevent changes. Any new baskets that are determined to be available for third-party inspection are posted at the host site.

The user's Store Vault further provides an electronic operably associated computer memory area for storing basket identity information from the Action Vault that is offered for sale at the host site. Basket identity information is received from the host of the baskets in the Action Vault that are offered for sale at the host site, and the area of computer memory electronically provided for storing such information is populated.

The user electronically transmits pricing information for the sale of basket information to the host site and for receiving electronic payments, credits, or notices from the host site for the sale of basket information.

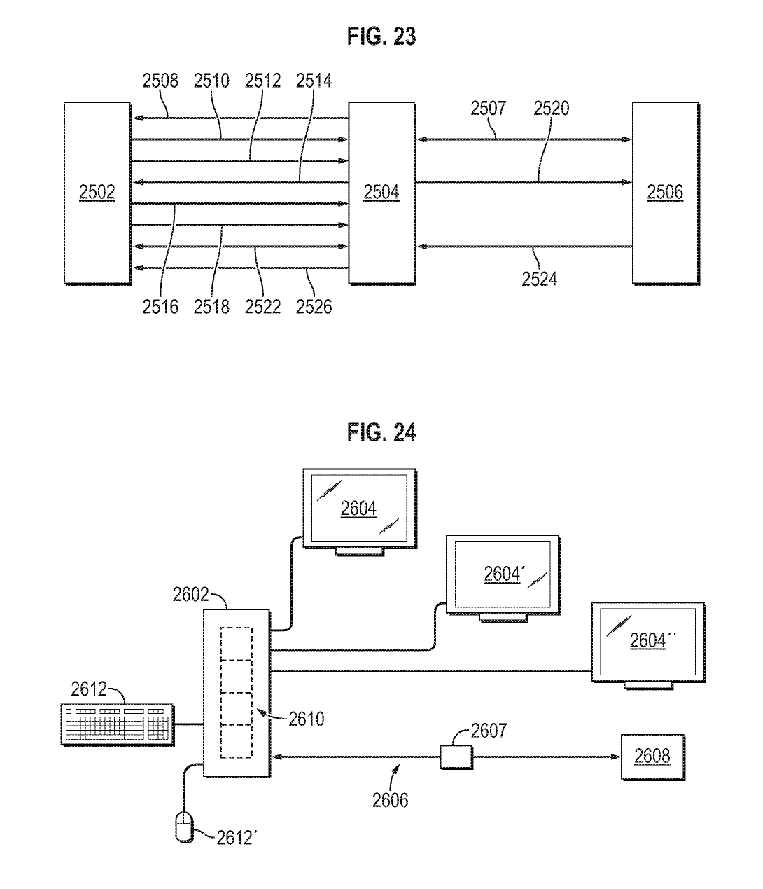

8. Where the third-party site is a host which acts as an intermediary between the user and a broker, the host will generally electronically receive from the user a description of a user-defined virtual investment portfolio. See FIG. 23. The portfolio will comprise at least one virtual basket, each of which has a virtual investment starting cash value and a composition comprising weighted amounts of at least a first electronically tradable investible and a second electronically tradable investible. The basket will have no automatic reweighting strategy unless specifically created. The identity and initial weighted amount of each electronically tradable investible is included in the description along with any potential reweighting strategy if such a feature can be accommodated by the third party. In addition, an indication of a desire to purchase the composition of a portfolio is electronically received from the user. An order to purchase the composition along with the formulation of the portfolio to be purchased for the user is electronically made available to a broker. The user and broker can modify through a suitable means the actual final cash value of any basket investments, thus providing a simple means of privacy for the user with respect to the host.

The host can essentially act as a middleman.

In one embodiment, the user electronically receives a confirmation that the order has been filled on behalf of the user in line with the formulation submitted. The confirmation can come directly from the broker. The broker can be paid directly by receiving electronic funds from the user or be paid electronically by the host.

The user can select the broker to be used and the host electronically receives an identification of the broker from the user, or a bidding process can be used. For example, the portfolio composition information can be electronically transmitted to a plurality of brokers, and at least one of them bids to fill the order. The information can be sent automatically or in response to a request from the brokers, and the bids are received by the user either via a host or directly from the brokers.

The method can be carried out by an electronic host server. The host can be compensated for services rendered by receiving electronic payments from the broker or by making the orders available on a website which brokers pay a fee to view.

As noted above, the weighted amounts are expressed as percentages of the virtual investment starting cash value, an aggregate of weighted amounts tallying 100 percent of the virtual investment starting cash value. See FIG. 12, for example.

The description of the portfolio is electronically locked in an Action Vault in a computer memory of the user device.

A performance chart for each of the at least one baskets is electronically posted for viewing by third parties online without displaying the composition details of the basket, generally at the host site.

A third-party user can electronically purchase a description of the composition of a basket that was selected after viewing the performance chart online, and automatically upon purchase will receive the description in the third-party user's electronic vault.

Users can paste the purchased basket details into another vault, modify the basket if desired, and place an order for its composition if desired.

When baskets are posted for viewing by third parties online, what is actually visible is an electronic performance chart for the basket. The composition details of the basket are not shown and have to be purchased. Each basket has a composition comprising weighted amounts of at least a first electronically tradable investible and a second electronically tradable investible. When an electronic payment to electronically access the composition details of the basket is received from a third party, the composition details are made available to the third party, preferably along with a performance graph or the data necessary to formulate one using the provided software. Preferably, the author of the basket is compensated such as by electronically transmitting a portion of the payment to the author. As the make-up of the basket can vary over time, the composition details electronically transmitted to the purchaser are preferably the same as on the author's starting date.

In the event that an author does not desire to sell his or her works, a payment can be received from the author for blocking electronic access to the performance charts by third parties. Electronic access can be blocked on a basket-by-basket basis.

The broker electronically receives from the host or the user a description of a user-defined virtual investment portfolio. The portfolio comprises at least one basket, each of which has a virtual investment starting cash value and a composition comprising weighted amounts of at least a first electronically tradable investible and a second electronically tradable investible. The broker also electronically receives from the user or from the host on behalf of the user an order for the real-world composition of the portfolio. The units of investibles to purchase can be communicated in non-unity or non-integer amounts by the host, or the host can be left out of the loop from the user directly without informing the host of non-unity investment values.

Where the weighted amounts are predetermined on a percentage basis and the description includes a description of the weighted amounts of the at least a first electronically tradable investible and a second electronically tradable investible, the amounts of each of the at least a first electronically tradable investible and a second electronically tradable investible in each basket, as measured in units, are adjusted to conform to the virtual investment starting cash value for the basket.

Where the user has a preexisting account with the broker who electronically fills the order and the account has a balance adequate to cover the order and fee charged by the broker, the method further comprises electronically debiting the account for the order plus fees. The host can be compensated electronically by transmitting a fee to the host. A fractional compositional description of each of the baskets can be electronically transmitted to the host. The description of the baskets typically electronically transmitted to the host does not include value information, but does include contents and weighting information.

A user can decide to reweight or otherwise modify a basket. The broker electronically receives a subsequent description constituting a modified form of the portfolio description previously received from the user. The broker electronically, by comparing the subsequent description to the previous description, makes adjustments to the previously described portfolio to achieve conformation with the subsequently described portfolio, and electronically executes all transactions required to achieve conformation. A report including a description of the baskets is electronically transmitted to the host.

A user can also sell a portfolio, in which case the broker electronically receives a sell order for the portfolio, executes it, and electronically notifies the host of the sale.

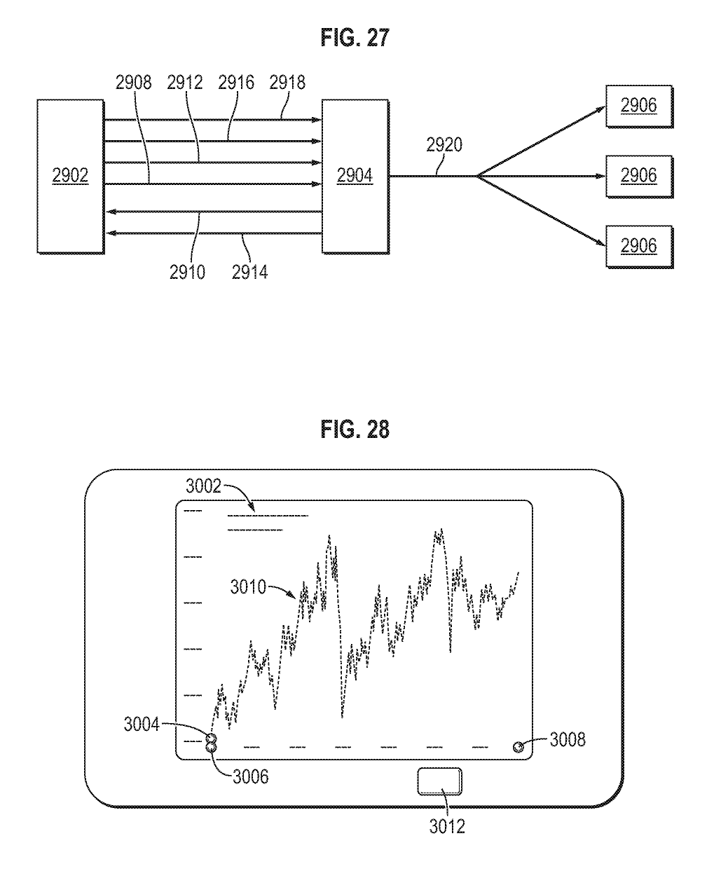

For a first-time user, the above real-world investing method steps are preceded by the broker electronically receiving a request to establish an electronic user account and if required, establishing the account. Such information can be securely saved by the host for easy retrieval later by the user. See FIG. 27.

The system electronically provides a means to electronically offer the services of brokers to a potential investor or electronically provides a means to automatically direct a request to a previously used or assigned broker. The system can directly electronically offer brokerage services, or it can electronically place a notice of intended trading allowing brokers to directly or indirectly solicit potential clients.

The description in the order typically includes the weighted percentages and the identities of the electronically tradable investibles, which are typically expressed as dollar values.

The weighting can be expressed as percentages of the virtual investment starting cash value, an aggregate of weighted amounts tallying 100 percent of the virtual investment starting cash value. See FIG. 10, for example. When the order is electronically executed, the amounts of each of the at least the first electronically tradable investible and the second electronically tradable investible in each basket, as measured in units, are adjusted to conform to the virtual investment starting cash value for the basket. The order is typically executed by a brokerage server and typically includes electronically receiving funds in the user account and electronically debiting the user account for the purchase plus brokerage fees.

After purchase, a performance chart for the at least one basket in the user-defined virtual investment portfolio is typically posted for viewing by third parties online. The third parties can electronically purchase compositional details by paying an electronic access fee, and the description will be electronically transmitted to them. A part of the proceeds can be electronically deposited into the user's account.

The online securities trading system which can be used for carrying out the methods described above generally comprises a first digital computer, a second digital computer, and an electronic communication system functionally connecting the first digital computer with the second digital computer. See FIG. 30. The first digital computer is typically on the broker end, and the second digital computer is typically on the client end. An application is present on the first digital computer for establishing and maintaining an online trading account for the client.

The application accommodates purchases and cash-out value tracking for at least one client portfolio where the portfolio comprises at least one client-specified basket. The at least one client-specified basket comprises client-proportioned percentages of at least a first electronically tradable investible and a second electronically tradable investible, and the basket is established in an initial virtual or real investment amount specified by the client. A virtual investment can be used for game purposes, for example. An application on the second digital computer, generally the client's computer, is for electronically selecting at least first and second electronically tradable investibles for which data sets of historical unit values are available from an electronic database. The application electronically provides for downloading the data sets and forming a virtual basket comprising weighted percentages of the first electronically tradable investible and the second electronically tradable investible. The application electronically provides for incorporating the virtual basket into a virtual portfolio and electronically transmitting data describing the virtual portfolio over the electronic communication system to the first digital computer for inclusion in the online trading account in the initial virtual or real investment amount.

Another embodiment of the invention electronically provides a graphing method. For a virtual or real investment made at a specified date and time of an allocated amount in an electronically tradable investible, optionally with a specified reapportionment strategy, there is displayed an algorithmically updated cash-out value graph over time. See FIG. 14, for example. An electronically tradable investible for which a data set of historical unit trading prices is available from an electronic database accessible by the digital computer is selected by use of a digital computer program accessing a digital information highway. The data set in the electronic database is electronically downloaded and/or accessed by the digital computer program. A numerical value for the allocated cash amount to be invested in the electronically tradable investible is provided for use by the digital computer program. The allocated cash amount can be the system default unitary allocation. An investment start date and time for the virtual or real investment in the electronically tradable investible are provided for use by the digital computer. The computer program calculates the number of investment units in the electronically traded investible by dividing the numerical value of the allocated total amount to be invested by the unit price of the tradable security at the investment start date and time. On an electronic display associated with the digital computer, the computer program displays a graph of virtual or real investment cash-out values as a function of date and time, over time, for the virtual or real investment. The cash-out value graph backward and (data permitting) forward from the investment start date and time over the date range is generated algorithmically by the digital computer program based on the calculated number of investment units, the investment start date and time, the apportionment strategy if adopted, and the historical unit trading prices accessed by the digital computer from the electronic database.

The electronic database used can be publicly available. The investible is selected from securities and currencies. The digital information highway can be the Word Wide Web or any other digital communication means for accessing electronic databases.

The purpose of the graph is for visualizing the performance history to enable trend tracking and evaluation of the performance of the virtual or real investment over time. The graph can have an adjustable/expandable/changeable time axis display range. The start date and time can be selected from an initial and a revisable start date and time. The range of dates is a display period. The numerical value for the allocated virtual or real cash amount can be selected from an initial value and a revised value and is provided by input from a user. The number of units is calculated by equating cash-in value at the investment time and date to the allocated real or virtual investment cash amount. The allocated amount typically does not equal a whole number of units of the electronically tradable investible.

Another embodiment of the invention electronically provides a system for displaying a cash-out value graph over a user-specified time for a virtual cash investment of an allocated amount at a specified time and date in an electronically tradable investible. The system comprises a digital computer, historical trade-price data, an electronic display, graphing software, interactive input software, and at least one user input device. See FIG. 24. The historical trade-price data is for the electronically tradable investible against time. It is stored in a database electronically accessible by the digital computer. The electronic display and graphing software are operatively associated with the digital computer. The graphing software is for processing the database for the period specified and electronically displaying a virtual investment cash-out value graph over this time for the virtual investment made at a specific time and date in the electronically tradable investible. The interactive input software is operatively associated with the digital computer. It is for accepting an initial or a revised virtual or real investment cash allocation and an initial or a revised specific starting date and time for the cash-out value graph as well as an initial or revised investment period. The at least one user input device is for inputting an initial or revised virtual investment cash allocation and an initial or a revised virtual investment date for the cash-out value graph and an initial or revised investment period.

The interactive input software further accepts input of a user-specified charting date range, and the at least one user-input device is functional to input a user-specified charting date range. The specific times and dates can thereby be user specified. The cash-out value graph is editable as well and can be of an initial or revised virtual investment amount. The database used can be publicly accessible.

A method for electronically displaying value changes of an initial virtual or real investment in an electronically tradable investible can be carried out on the just-described system. The cash value against time data is electronically received for the at least one electronically tradable investible from a database. Inputs establishing the initial or revised starting cash value for the cash value graph are received. The cash value against time data, the initial or revised starting cash value, and the initial or revised investment starting date are electronically processed with the graphing software for an initial or revised investment period. The cash value graph of the changes in cash value over time over the desired period based on the initial or revised starting cash investment is displayed on the electronic display.

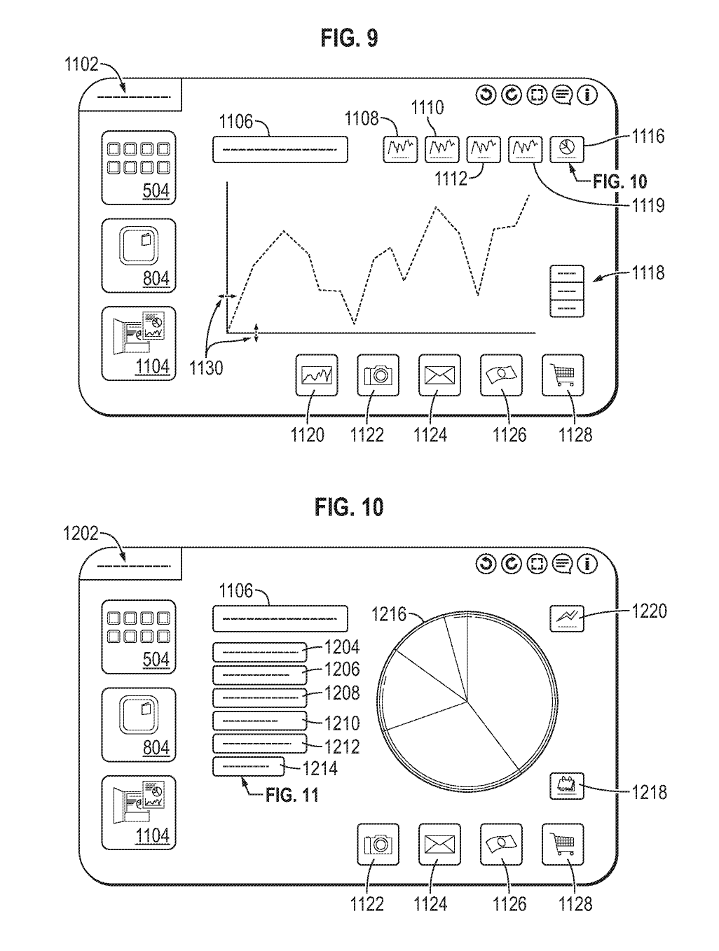

Another embodiment of the invention electronically provides a method for displaying a graph representative of performance over a defined time period of a collection of electronically tradable investibles in a virtual basket comprised of apportioned/weighted percentage holdings of electronically tradable investibles presented as percentage proportions of the total virtual basket, optionally along with a reapportionment strategy based on time period or event triggers. See FIG. 9, for example. The basket is comprised of at least a first electronically tradable investible and a second electronically tradable investible. An initial default investment starting date for the basket is electronically provided for use by the digital computer, with a default charting time period being used to electronically display an initial chart. A first electronically tradable investible for which a data set of historical unit trade-prices is available from an electronic database accessible on a digital information highway is selected for use of the digital computer. The data set for the first electronically tradable investible is selected by use of the digital computer from the electronic database for use in calculating cash-out values for the basket. A second electronically tradable investible for which a data set of historical unit trade-prices is available from an electronic database accessible on a digital information highway is selected for use of the digital computer. The data set for the second electronically tradable investible is accessed by use of the digital computer from the electronic database for use in calculating cash-out values for the basket. Weightings for the at least the first electronically tradable investible and the second electronically tradable investible are initially equally apportioned electronically to make up the basket on the basis of percentages, and a reapportionment strategy is not employed. The sum of all electronically tradable investibles making up the basket is selected from unity, 100 percent, or an allocated cash value for the basket as of the investment starting date. A cash-out value graph is displayed on an electronic display associated with the digital computer illustrating the historical cash-out values for the total basket backward and (data permitting) forward from an investment starting date as well as the relative apportionment of each component of the basket. The initial default investment starting date, apportionments, charting time ranges and total basket values, and reapportionment strategies can be easily modified for recalculation and electronic display updating by the computer. For example, the apportionment strategy might be to readopt the initial apportionment at the start of every month.

The sum of all electronically tradable investibles making up the basket is 100 percent or unity as of the investment starting date and time. However, the graph is preferably convertible from percentage value to cash value by use of the digital computer. The investment starting date is selected from a virtual starting date or an actual starting date, and it also can be selected from an initial starting date and a revised starting date. The allocated cash value for the basket can be virtual or real.

The cash-out value graph has a selectable charting time range, and the charting range is editable. Preferably, the cash-out value graph visually stacks apportioned weightings for each of the electronically tradable investibles separately and more preferably, separately color-codes an apportionment for each component of the basket.

Another embodiment of the invention electronically provides a system for electronically displaying a cash value graph representative of performance over time of a virtual or real investment in a basket comprised of weighted amounts of at least a first electronically tradable investible and a second electronically tradable investible. See FIG. 24. The system comprises a digital computer, an electronic display, a communication system, an electronic database, an application, graphing software, interactive software, and at least one user input device. The electronic display is operatively associated with the digital computer. The communication system is operatively associated with the digital computer and is connected to a digital information highway. The electronic database contains data sets of historical unit values for at least a first electronically tradable investible and a second electronically tradable investible accessible from the digital computer via the communication system. The application is on the digital computer and is for electronically retrieving the data sets and mathematically electronically forming a virtual basket comprised of weighted percentages of the first electronically tradable investible and the second electronically tradable investible. The graphing software is operatively associated with the digital computer and is for electronically displaying a cash value graph of the cash value of the virtual basket against time on the electronic display. The interactive software is operatively associated with the digital computer and is for accepting a cash value and a starting date for the virtual basket and optionally changes in starting cash value, apportionments, charting periods, and reapportionment strategies. The at least one user input device is for providing inputs for acceptance by the interactive software, including starting cash value and the starting date and time for the virtual basket.

Another embodiment of the invention electronically provides a system for displaying a cash-out value graph representative of performance over time of a virtual or real investment in a portfolio comprising at least two virtual baskets, each comprised of weighted amounts of electronically tradable investibles. The system comprises a digital computer, an electronic display operatively associated with the digital computer, a communication system operatively associated with the digital computer and connected to a digital information highway, an electronic database containing data sets of historical unit values for each of the electronically tradable investibles accessible from the digital computer via the communication system, an application on the digital computer for retrieving the data sets and forming mathematical models of the virtual baskets, an application on the digital computer for combining the mathematical models of the virtual baskets and forming a mathematical model of the portfolio, graphing software operatively associated with the digital computer for displaying a cash-out value graph of the cash-out value of the portfolio against time on the display, and software operatively associated with the digital computer for accepting a starting cash value and a starting date for each of the virtual baskets.

Preferably, the system includes at least one user input device for inputting the starting cash value and the starting date for each of the virtual baskets, and the graphing software visually stacks cash-out value contributions from each of the virtual baskets in the cash-out value graph for the portfolio and more preferably, separately color-codes the cash-out value contributions from each of the virtual baskets.

The just-described system can be used in a method for forming a virtual basket comprising a first electronically tradable investible and a second electronically tradable investible. In the method, the data sets for the investibles are electronically accessed. Inputs are received establishing the initial or a revised starting cash value and an initial or a revised investment starting date for the cash value graph. The data sets, the initial or revised starting cash value, and the initial or revised investment starting date and optional reapportionment strategies are electronically processed with the graphing software over a specified or revised time period. The cash-out value graph for the virtual basket over time based on the initial or revised virtual or real investment starting cash value and initial or revised investment starting date and optionally a virtual or real reapportionment strategy is displayed on the electronic display.

In another embodiment of the invention, a method is provided for non-automatically reallocating weighted cash-out values to a first electronically tradable investible and a second electronically tradable investible in a virtual basket comprising at least a first and a second electronically tradable investible wherein the basket has an overall cash-out value. See FIG. 9. A unity diagram having an area representing 100 percent of the overall cash-out value of the basket is displayed on an electronic display operatively associated with a digital computer. At least one divider element dividing the area into at least two subareas proportionally representing weighted cash values for the first electronically tradable investible and the second electronically tradable investible is displayed on the unity diagram. The size of one of the subareas is adjusted with a user input device coupled to a digital computer. The size of the at least one other subarea is responsively adjusted with a self-executing software application residing on the digital computer.

The user input device can be selected from a keyboard, a mouse, a touch screen, or an eye motion sensor, for example. The adjustment is entered by moving the divider element to a new location on the area by use of the user input device which is operatively associated with the display. The divider element is then immobilized in the new location by use of the user input device to reallocate the weighted cash-out values between the first electronically tradable investible and the second electronically tradable investible. The subareas proportionally represent the reallocated cash-out values. In a preferred embodiment, the adjustment can be entered by selecting an area with a user input device and entering a numerical allocation with the same or a different user input device.

Another embodiment of the invention electronically provides a method for displaying change over time for relative contributions by individual components making up a virtual basket. The components comprise at least a first electronically tradable investible and a second electronically tradable investible. The method is carried out by accessing data sets of historical unit trade-prices for the components of the virtual basket by use of a digital computer, by accessing weightings for the components of the basket on the basis of part of the whole, or percentages, as of an investment starting date, the sum of all components being selected from unity, 100 percent, and a virtual or real investment cash-out value, by displaying on an electronic display operatively associated with the digital computer a unity diagram having an area representing 100 percent of the overall cash-out value of the basket at any given time, and by displaying on the unity diagram at least one divider element dividing the area into at least two subareas proportionally representing weighted cash-out values for each of the components of the basket at any given time supported by the data sets.

The sum of all the components can be expressed as 100 percent, or alternatively as a virtual or real investment cash-out value. The weightings for the components can be input by the user on the virtual or real investment starting date on a percentage basis or based on the actual number of units.

In a preferred embodiment of the invention, a graph of the performance of the basket against time is displayed alongside the unity diagram. In the graph, the value of the investibles is an independent variable with time, and the cash-out value is dependent on the value of the investibles as well as time. In a further preferred embodiment of the invention, a date on the graph is selected, and by use of the digital computer and the data sets and a suitable algorithm, the subareas of the unity diagram are automatically adjusted proportionally to represent the weighted cash-out values for each of the components as of the selected date. Where the unity diagram comprises a pie chart and the apportionments are illustrated as slice-shaped subareas, the slices change in size with date selection to illustrate relative changes in apportionment caused by changing trade-prices over time since the number of tradable units is determined and fixed on the initial investment date.

Preferably, the subareas of the unity diagram are color-coded differently for each of the components.

If desired, by use of the digital computer, the number of units of each component in the basket as of the investment date can be determined and multiplied by the respective historical values from the data sets as of a selected date to determine the cash-out values as of the selected date. The historical unit trade-prices for the components of the virtual basket can be accessed on a digital information highway, the Internet for example.

New weightings for the components of the basket can be input by the user on the basis of parts of the whole, or percentages, as of an adjusted virtual or real investment starting date, the sum of all components being selected from unity and 100 percent. The changes are preferably immediately displayed on the unity diagram with at least one divider element dividing the area into at least two subareas proportionally representing the newly weighted cash-out values for each of the components of the basket at any given time supported by the data sets. More preferably, all changes to the composition of a basket are immediately displayed on the unity diagram with at least one divider element dividing the area into at least two subareas proportionally representing the weighted cash-out values for each of the components of the basket as thus changed at any given time supported by the data sets.

One embodiment of the invention electronically provides a method for illustrating relative cash values embodied by unity diagrams with respect to other objects displayed on a computer display device. The method is carried out by sizing the unity diagrams and the other objects shown on the computer display device proportionate to their cash values. For example, the electronic display can illustrate a portfolio composed of a plurality of virtual baskets of electronically tradable investibles, and the unity diagrams illustrate baskets within the portfolio.

The unity diagrams can comprise pie charts composed of color-coded slices, for example.

In a further embodiment of the invention, a method is provided for allocating apportioned starting cash values for a first electronically tradable investible and a second electronically tradable investible making up a virtual basket. The method requires a digital computer, a display, an electronic database, an application, cash value graphing software, and interactive software. See FIGS. 9, 10 and 24. The electronic display is operatively associated with the digital computer. The electronic database contains data sets of historical unit values for at least a first electronically tradable investible and a second electronically tradable investible. An application resides on the digital computer for retrieving the data sets and mathematically forming a virtual basket comprising weighted percentages of the first electronically tradable investible and the second electronically tradable investible. The cash value graphing software is operatively associated with the digital computer for displaying on the electronic display a cash value graph for the virtual basket against time. Interactive software operatively associated with the digital computer for accepting an initial or revised starting cash value and an initial or revised investment starting date for the cash value graph is provided. Interactive software is operatively associated with the digital computer for displaying on the electronic display a unity diagram representing 100 percent of the starting cash value of the basket. Interactive software is operatively associated with the digital computer for displaying on the unity diagram at least one movable divider element dividing the area into subareas proportionally representing apportioned starting cash values for the first electronically tradable investible and the second electronically tradable investible. Interactive software is electronically provided for moving the divider element or otherwise adjusting the apportionment and for inputting an initial or a revised starting cash value and an initial or a revised investment starting date for the basket. The adjustment can be done directly by the user or by an automatic reapportioning strategy developed based on the occurrence of a triggering event. The system receives a user command or detects the occurrence of a predetermined triggering event and produces an automatic command to reallocate the apportioned starting cash values between the first electronically tradable investible and the second electronically tradable investible according to the predetermined strategy. The cash value graph is recalculated in view of the reallocated cash values, and the recalculated cash value graph is displayed.

In a preferred embodiment, the interactive software causes a cursor to be displayed and in conjunction with a user input device, electronically provides a means for moving the divider element with the cursor.

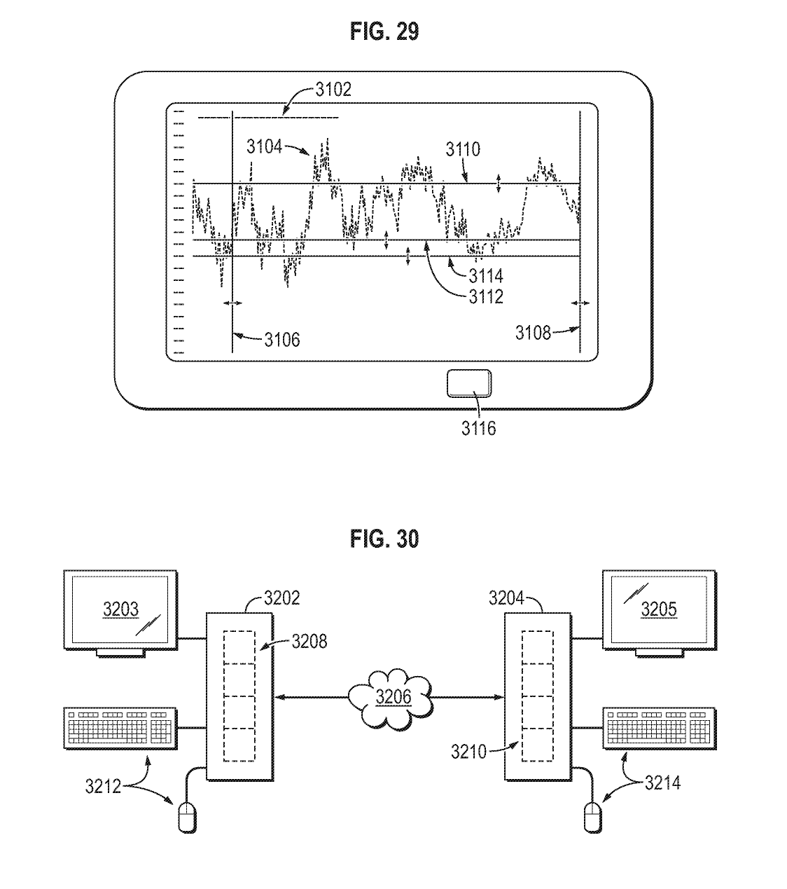

Another embodiment of the invention provides a method for electronically displaying relative historical cash-out value differences and trends in virtual cash-out values between a first virtual or real basket comprising at least one first electronically tradable investible and a virtual or real second virtual basket comprising at least one second electronically tradable investible. See FIGS. 26 and 29. A first virtual or real basket comprising at least one first electronically tradable investible for which a first data set of historical cash values is available from an electronic database is established. A second virtual or real basket comprising at least one second electronically tradable investible for which a second data set of historical cash values is available from an electronic database is established. The first data set and the second data set are accessed by use of the digital computer from the electronic database. Equal initial virtual or real investment starting cash values for the first virtual or real basket and the second virtual or real basket are established. A virtual or real investment starting date for the initial virtual or real starting cash value is selected by use of the digital computer. A cash value graph of the difference in change between the first virtual or real basket cash value and change in the second virtual or real basket cash value, said difference being expressed as a percentage change against time forward and/or backward from the virtual or real investment starting date, is calculated by the digital computer and is displayed on an electronic display associated with the digital computer.

In one example, the first virtual basket can represent a real investment, and the second virtual basket can represent a virtual investment. The basket performances can be monitored with a view to determining whether a switch between them is advisable. The at least one first electronically tradable investible and the at least one second electronically tradable investible can be selected, for example, so that the relative value graph oscillates up and down over time, the graph being representative of the relative values of the baskets and having portions indicative of arbitrage or reweighting opportunities.

Another embodiment of the invention electronically provides a system for displaying relative price differences and trends in value between a first virtual basket comprising at least one first electronically tradable investible and a second virtual basket comprising at least one second electronically tradable investible. The system comprises a digital computer, a display, a communication system, an electronic database, an application, interactive software, and at least one user input device. See FIG. 24. The electronic display and the communication system are operatively associated with the digital computer. The electronic database is accessible by the digital computer via the communication system. It contains digital data sets of historical unit values for the first electronically tradable investible and the second electronically tradable investible. The application is on the digital computer. It is for accessing the data sets and displaying on the electronic display a graph of a difference in change between a first virtual or real investment cash value and change in a second virtual or real investment cash value, said difference expressed as a percentage change against time. The interactive software is operatively associated with the digital computer for accepting an initial or revised virtual or real investment starting date for the cash value graph. The at least one user input device is for inputting the initial or a revised starting date, said first basket and said second basket being of the same virtual or real investment starting cash value as that of the initial or revised investment starting date.

Another embodiment of the invention provides a method for electronically displaying relative price differences and trends in value between a first virtual basket and a second virtual basket using the just-described system. The data sets are electronically received by the digital computer. An input establishing the initial or the revised investment starting date for the graph is received by the digital computer. The data sets and the investment starting date are processed with the graphing software. The graph of the difference in change between the value of the first virtual basket and the second virtual basket is electronically displayed.

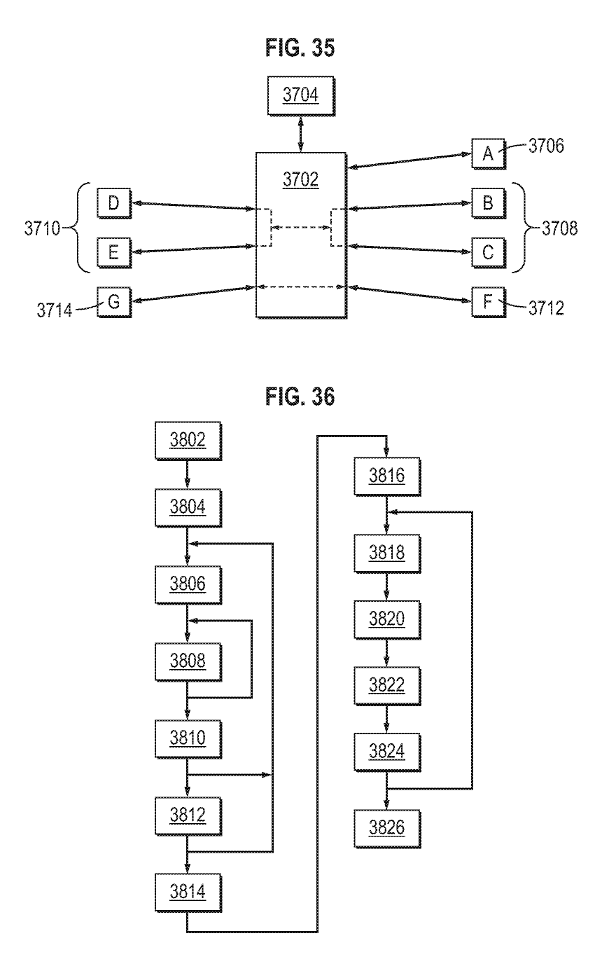

Another embodiment of the invention provides an electronic gaming method. In the method, an online game forum is electronically provided for a virtual basket investment competition where each basket is comprised of electronically traded investibles. See FIG. 35. Types of game formats, historical time periods for fast games or future-based games, number of players and player teaming, genres, and rules are electronically posted on the internet forum for conducting the competition, including the start date and the ending terms. Downloadable software is provided for forming the virtual investment baskets. Virtual investment baskets are received online from competitors for entry into the competition prior to the start date. The competition is started. Performance graphs are made available online for portfolios or baskets entered into the competition. The competition ends when the ending terms are met, and a winner of the competition is electronically posted on the game forum.

The rules can include providing times and means to amend portfolios in agreement with specific rules of a specific game.

A platform can be electronically provided to organize games for a single player, a player against another player, and multiple players against multiple players. Prizes can be awarded to the winners.

Ongoing performance results can be made immediately available if the game is based on a historical period with existing data, or live if it is being played in real time.

The games can be set up to generate fees for the host. For example, a fee can be collected online from a player to make specific basket composition information available online. Payment of the fee would make that specific basket composition information available online to the player.

A fee can be collected online from a player to make specific portfolio composition information available online from another player. Payment of the fee would make that specific basket composition information available online to the player.

A fee can be collected from a player to make specific basket composition information unavailable online. Payment of the fee would make that specific basket composition information unavailable online to other requestors.

A fee can be charged for viewing a competitor's basket.

It is anticipated that competitors would be electronically provided with online electronic access to a database of investibles for formulating baskets of investibles for game purposes. The database can be open-ended as to date if desired or close-ended as to date range and listed investibles, depending on the game.

In certain games, competitors can have a limited number of options to adjust portfolio composition during the course of the game, with the exercise of each such option counting as a move, and the game can be terminated after a predetermined number of moves. Other end points can be reached when a player reaches a predetermined profit, reaches a predetermined loss, or after the passage of a predetermined period of time.

Other games can be more open-ended concerning adjustments to portfolio composition online from competitors during the course of the game, or the rule can permit a competitor to enter more than one portfolio, optionally on payment of more than one entry fee. Where the rules for conducting the competition further permit amending the portfolio composition, it is expected that amendments to portfolio compositions as permitted by the rules would be received during the course of the competition.

Where the rules for conducting the competition further permit class awards based on competitors' previous game performances, the method can further include establishing a competitor classification system based on each competitor's previous game performance, classifying the competitors according to the classification system prior to the starting date, and posting the winners of the class awards on the game forum at the end of the competition.

The downloadable software provides a user having a digital computer and electronic access to a digital information highway the means for forming portfolios from aggregations of baskets and the means for evaluating baskets. Evaluation can be essentially as described before, proceeding by the steps of providing for use by the digital computer an investment starting date for the basket, selecting by use of a digital computer a first electronically tradable investible for which a data set of historical unit trade-prices is available from an electronic database accessible on a digital information highway, accessing the data set for the first electronically tradable investible on the digital computer from the electronic database for use in calculating performance for the basket, selecting by use of a digital computer a second electronically tradable investible for which a data set of historical unit trade-prices is available from an electronic database accessible on a digital information highway, accessing the data set for the second electronically tradable investible on the digital computer from the electronic database for use in calculating performance for the basket, apportioning weightings for the at least the first electronically tradable investible and the second electronically tradable investible to make up the basket on the basis of percentages, the sum of all electronically tradable investibles making up the basket being selected from unity, 100 percent, or an allocated cash value for the basket as of the investment starting date, and displaying on an electronic display associated with the digital computer a cash-out value graph illustrating the historical cash-out value for the total basket backward and (data permitting) forward from the investment starting date and the relative apportionment of each component of the basket.

The downloadable software can require that the sum of all electronically tradable investibles making up the basket is 100 percent as of the investment starting date, further that the cash-out value graph visually stacks apportioned weightings for each of the electronically tradable investibles separately, and further that the cash-out value graph separately color-codes an apportionment for each component of the basket.

In a preferred embodiment, the downloadable software electronically provides the user with the option of creating a virtual vault for gaming with password protection. It is further preferred to electronically provide on the game forum a means for the competitors to electronically communicate with each other. It is additionally preferred to provide electronic public access to the performance graph postings for the baskets and the ability to purchase composition information for the baskets. It is further preferred to electronically provide on the game forum competitor ranking information.

Tournaments can be conducted. The rules for conducting the competition can further provide for the elimination of players at specific time points to reduce the number of players to produce finalists. Players would then be eliminated as permitted by the rules.

For two-person competitions, virtual investment portfolios are received from only two competitors. The method further comprises providing rules for two competitor games wherein the competitors select game options prior to the start date. The competitors submit their game option selections, and the game is conducted from the options so selected.

For a one-person game, a virtual investment portfolio is received from only single competitors. The method further comprises providing rules for single competitor games, the competitor selects game options prior to the start date, and the game is conducted according to the options selected.

For team competitions, virtual investment portfolios are received from teams of multiple competitors. Rules are provided for competitor games. The competitors select game options prior to the start date, and the game is conducted according to the options selected.

Typical game options can include types of games, types of investibles, historical or real-time games, and time periods for games. The contents of the virtual investment portfolios can be selected from a closed group of investibles. Archive copies of the game transactions can be saved by the sponsoring sites. Means can be electronically provided on the game forum for a competitor to electronically seek assistance from other users or assistance in basket creation.

Competitors can comprise groups of collaborating competitors. Virtual baskets of electronic investibles from other authors for downloading and forming the portfolios can be electronically provided on the game forum or an affiliated site. A fee can be collected for each basket which is downloaded. The virtual baskets contained in the winning portfolio are offered for downloading from the game forum or an affiliated site for a fee.

Another embodiment of the invention electronically provides a method that uses of a digital computer, an electronic display, a communication system, an electronic database, an application, interactive software, and at least one user input device. See FIG. 36. The method comprises (a) electronically opening a virtual Ideas Vault, (b) creating a virtual investment portfolio in the vault, (c) allocating a virtual investment amount to the portfolio, (d) creating a virtual basket in the portfolio, (e) allocating part of the investment amount to the basket, (f) selecting a virtual investible for the basket, (g) repeating step (f) with different investibles to populate the basket, (h) apportioning, by use the digital computer and the interactive software, the basket cash allocation between the investibles on a percentage basis, (h1) optionally developing a reapportionment strategy for the basket based on the occurrence of a triggering event, (i) repeating steps (d)-(h) to form different baskets within the portfolio if desired, (j) reallocating cash between different baskets if desired, (k) moving the portfolio to a virtual Serious Stuff Vault, (l) selecting a real-world broker, (m) executing purchase in reality of the portfolio, (n) broker electronically moving a record of executed portfolio to user's Action Vault, and (o) user being able to make modifications by repeating steps (k)-(n) with an indication to the broker that the modified portfolio is to be a replacement.

Once a basket of stocks, with associated percentage weighting of the investibles has been established, an investment start date and time determines the unique point where the relative apportionment is precisely the same as that which was entered. From any time on, looking from a historical charting perspective, or in a live scenario, the relative apportionment VALUES will change, since the number of units of each investible is constant, but the unit values are fluctuating.

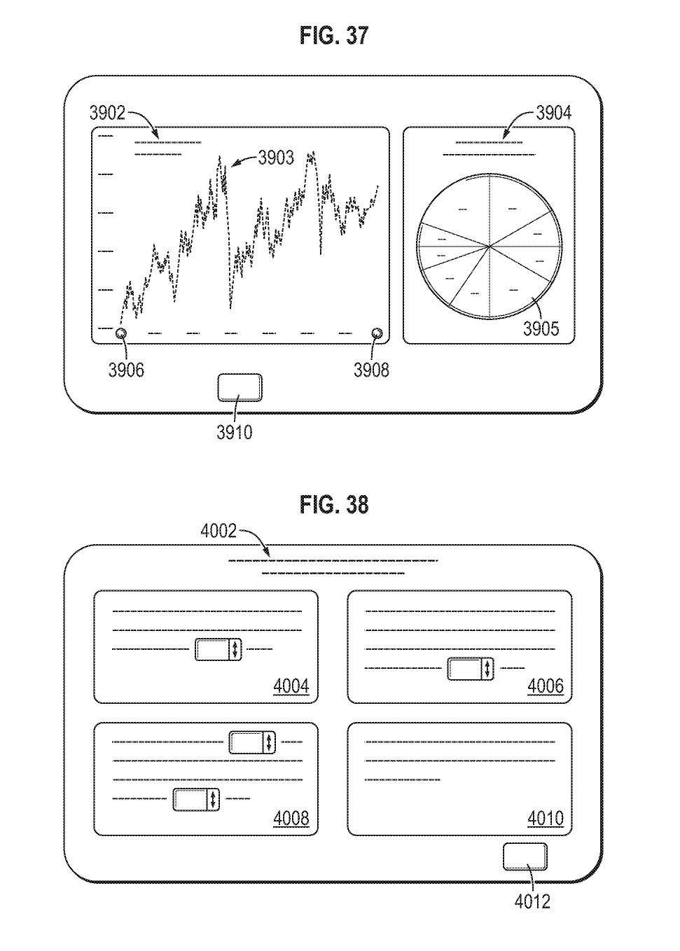

Using one embodiment of the invention, automatic or tickled reapportionment strategies can be created. Such strategies are based on trigger events, and the reapportionment action to be taken (which may simply be a notification to the user) is automatically applied on the occurrence of the triggering event. The effect of executing such reapportionment strategies can be charted, as a function of investment period and investment start date, to evaluate the effectiveness of any reapportionment. See FIGS. 37 and 38.

In a preferred embodiment of the invention, a reapportionment strategy for a basket is created by clicking on a basket icon to select the basket and choosing an option button labeled reapportionment strategy. Pressing the button brings up a list of previously created reapportionment strategies that can be applied by turning them on or off. Multiple strategies can be turned on or off for any basket.

It is within the scope of the invention to electronically provide several standard schemes with adjustable variables such as period or numerical values for percentages as part of the program, but special schemes can be created or purchased.

To create strategies, two parameters are set, the first being the trigger event and the second being the action to be implemented automatically upon the trigger conditions being met. The trigger event possibilities and action events can be conditional on multiple events (“and” statements), or on one of several possible events (“or” statements), and various combinations as the user may wish to experiment with. Conditional statements are logically organized. Development of such items may require a specialized and more advanced aspect of the program.

Three general triggers are considered basic tools:
Period—say every month, annually, etc
Actual tradables' levels in a basket—for example, if a tradable moves above or below a level, or a relative weighting level change with respect to others. Say three stocks are in a basket, a trigger could be set when a stock drops or increases by x %, or the relative movement between 2 stocks is y %, or the value of all the stocks increase by z % collectively.
Using external event triggers, such as market news, dividend dates, index levels, moving averages and so on.

The simplest reapportionment strategies involve reestablishing the original value apportionment ratios, or creating new ratios to be set at trigger events.

Once schemes are created as tools, they can be selected and applied to a basket (schemes become tools that can be allocated to any basket), and turned on and off to see the effect of executing the strategy over the time periods being historically charted. On the chart, triggered events can be shown by markers such as vertical lines to indicate a reapportionment from a trigger event.

Once portfolios are established in the real world, the system will alert the user of the occurrence of a triggering event, or the broker can be advised automatically of a change to be implemented.

A few practical simple examples:

1) A scheme that periodically returns a basket back to the initial apportionment. Variable to be set—trigger period, say every 6 months. This scheme amounts to a simple “buy low, sell high” scheme.
2) A scheme that returns a basket back to initial apportionment if the relative value of any 2 stocks in the basket moves by more than a predetermined percentage, say, 10%, since the investment date, or last reapportionment. This scheme amounts to an arbitrage model.
3) A scheme that sells a portion of stocks in a basket falling 5% below the average of the basket's performance, and purchasing more of baskets winning stocks. This is a scheme for dumping poor performers.

### DESCRIPTION OF DRAWINGS WITH REFERENCES

102 page title: MiETF Vaults
104 button for copy/paste
106 button for chat
108 button for information
110 button for samples
112 button for Ideas Vault
114 button for tracking
116 button for Serious Stuff Vault
118 button for Store
120 button for Games
122 button for creating new Vaults
124 button for Action Vault
126 present screen button
128 continuation of screen button
202 pop-up for login—“Please Enter Vault Pass code”
204 window for keying in pass code
206 button for entering keyed in pass code
208 button to exit pop-up
302 vault identification/customization page
304 window for keying in new name of vault
306 buttons for selecting new color to be associated with vault
308 window showing pass code associated with vault
310 button for saving entries/changes
312 button to delete vault
402 pop-up for confirming deletion of vault—“Do you wish to remove this vault”
404 button to confirm deletion of vault
406 button to close pop-up
502 page title MiETF Samples Vault
504 palette showing buttons for selecting vaults “Vaults”
506 pop-up for setting numerical pass code
508 window with combination spinners for selecting code
510 button to save selected combination “SET”
602 screen image for dialing in combination for access
604 window with combination spinners for inputting access code
606 button to electronically access vault after inputting electronic access code
702 screen image showing portfolios in MiETF Samples Vault
704 Examples portfolio hot area
706 hot area to add new portfolio
708 button to exit and log out—“LOCK”
802 page title MiETF Examples Portfolio
804 palette showing button(s) for selecting portfolio in open vault “Portfolios”
806 cascade of hot ETF data images to enable selection of particular ETF
808 hot image to electronically access “Blue Chip, Sample 1” data
810 hot image to electronically access “Pharma, Sample 2” data
812 hot image to electronically access “Mixed ETF, Sample 3” data
814 hot image to electronically access ETF builder tools
816 buttons to electronically access additional ETF data images
917 hot image to electronically access “Mixed ETF, Sample 4” data
918 hot image to electronically access “Finance, Sample 5” data
920 hot image to electronically access “Commodities, Sample 6” data
1002 screen display for setting up password recover
1004 Legend—System recovery password—Before locking this vault for the first time, please set a system recovery pass word. This system recovery password is required to recover any forgotten vault pass codes.
1006 window to input master password “Master Password”
1008 window to re-enter master password “Re-type Password”
1010 window to input password hint “Password Hint”
1012 Legend—Master Password Saved—The Master Password can be changed by pressing 1, where system settings and help information can be found
1014 Save button
1102 page title MiETF Historical Performance
1104 palette showing hot areas for selecting different ETFs in the open portfolio
1106 title of MiETF “Plasma, Sample 2 MiETF”
1108 button for accessing enlarged MiETF screen shot
1110 button for accessing enlarged Dow screen shot
1112 button for accessing enlarged NASDAQ screen shot
1114 button for adding traces to the selected screen shot
1116 button for showing formulation percentages for selected screen shot
1118 button array for changing the period shown on the chart—1 month, 6 months, etc.
1120 button to change to full screen view
1122 button to open snap shot tool
1124 button to export display to other applications
1126 button to initiate sell (or buy) instructions to broker
1128 button to electronically access MiETF Store
1130 adjuster bars to change ordinate and abscissa positions
1202 page title MiETF Components
1204 legend—stock component 1 (MRK)
1206 legend—stock component 2 (JNJ)
1208 legend—stock component 3 (ANZ)
1210 legend—stock component 4 (BMY)
1212 legend—cash component 5 ($)
1214 open tool to add component
1216 pie chart of holdings in ETF
1218 open tool to reweight holdings
1220 open tool to graph holdings
1302 page title MiETF Stock Sectors
1304 Industrials
1306 Consumer
1308 Consumer staples
1310 Health
1312 Financials
1314 Information Technology
1316 Telecom Services
1318 Utilities
1320 Energy
1322 Materials
1324 button to open ETF selection menu
1326 button to open stock selection menu
1328 button to open bond selection menu
1330 button to open currencies menu
1332 button to open MiETFs menu
1334 button to open search bar
1402 page title MiETF Healthcare Component
1404 component 1 (MRK data button)
1406 component 2 (JNJ data button)
1408 component 3 (AZN data button)
1410 component 4 (BMY data button)
1412 component 5 (AZN data button)
1416 button for alphabetical stock listing
1418 button for market capitalization stock listing
1420 button for stock listing based on volume
1422 button for stock listing based on P/E
1424 button for stock listing based on dividend yield
1426 button for random stock
1428 button for listing of S&P

Additional buttons could be provided on any of the screens if desired. For example, a button to launch streaming current audio or video news feeds (news agglomerators) for each of the held components, or scrolling current printed news and/or stock tickers for each of the held components, or for components being watched. Also, a program to launch one or more of the basket summaries as a screen saver, or as a window in the screen saver, or a software program to provide access to one or more of the charts using the favorites or tab functions in the user's web browser, or as a hidden or minimized screen, is within the scope of the invention.
1502 page title MiETF Merck & Co, Inc.
1504 graph of stock price vs. time (1 yr) for Merck & Co
1506 slider bars for adjusting ordinate and abscissa
1508 button to change graphing period
1510 button to electronically access news feeds for Merck & Co
1512 button to compare Merck & Co. to a different stock
1514 button to add Merck & Co. to Pharma, Sample 2 MiETF
1602 pop up menu to change graphing period
1702 graph of stock price vs. time (1 yr) with adjusted ordinate and abscissa
1802 page title MiETF Ideas Vault
1804 palette showing buttons for selecting vaults “Vaults” (similar to 504)
1806 screen image showing portfolios in MiETF Ideas Vault
1808 Portfolio titled 401k
1810 Portfolio titled Paul's Education
1812 Portfolio titled My New Boat
1814 Add Portfolio tool access
1816 Buttons for accessing additional pages
1902 page title Ideas Vault
1904 Sample Portfolio 1
1906 Sample Portfolio 2
2002 Title Sample Portfolio (Initial Value $25,000)
2004 legend-Today's value $25,000
2006 ETF icon titled “Small Cap 1”
2008 ETF icon titled “Precious Metals”
2010 Cash
2012 ETF icon titled “ETFs”
2014 ETF icon titled “Bonds”
2016 ETF icon titled “Medical Cos”
2019 ETF icon titled “Foreign Currencies”

In FIG. 18, click on any portfolio, or “zoom” to enlarge to see detail. Double click to edit name. Click folders (pie charts) to see performance charts, make changes, additions, delete, or reapportion your investments. Click “CASH” to add funds to portfolio. Click blank area in the vault green space to ad or paste a new portfolios (clicking opens an option box). Click white space to add or import/paste a new folder.
2102 Title “Serious Stuff” Vault
2104 Portfolio icon titled “Trust 1 Portfolio”
2106 Portfolio icon titled “Retirement Portfolio 1”
2108 Portfolio icon titled “Trust 2 Portfolio”

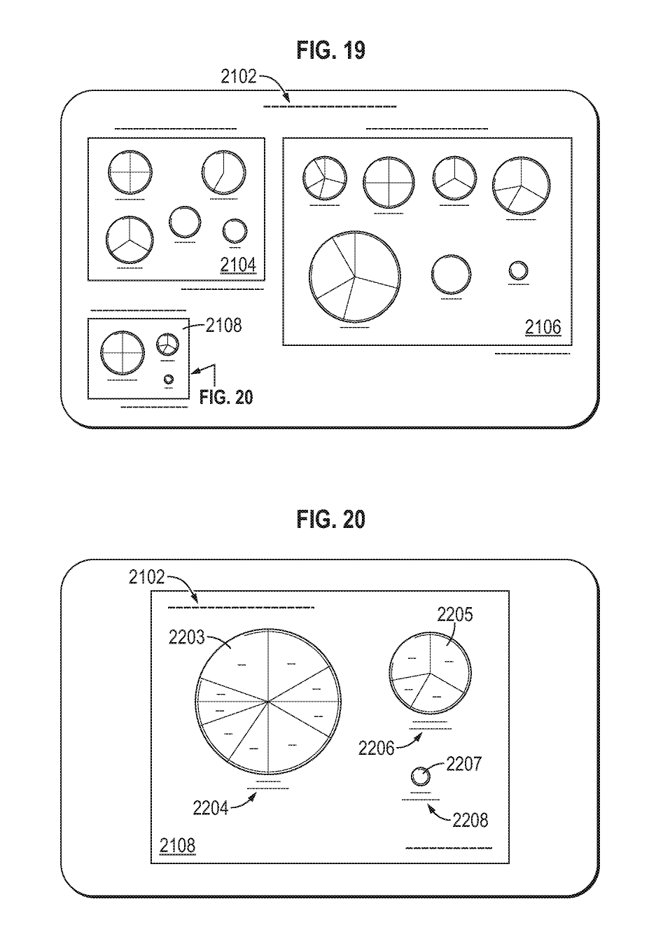

In FIG. 19, click on any portfolio, or “zoom” to enlarge to see detail. Double click to Edit name. Click folders (pie charts) to see performance charts, make changes, additions, delete, or reapportion your investments. Click “CASH” to add funds to portfolio. Click blank area in the vault green space to ad or paste a new portfolios (clicking opens an option box).
2202 Title “Trust 2 Portfolio” (Initial Value $15,000)
2203 ETF icon
2204 Legend “Folder 1, $28,765”
2205 ETF Icon
2206 Legend “Folder 2, $14,947”
2207 Cash Icon
2208 Legend “Cash $2,000”

In FIG. 20, click on a folder (pie chart) to zoom and focus on a folder, so that the trade item labels appear. Double-click a folder to change weighting/cash apportionment. Remember, you must have cash in your portfolio to increase a weighting, or you need to reduce (sell) from another folder first to make available more cash. You can also deposit cash by increasing the portfolio value. Click the blank white space to create a new folder. Click (hold shift) and click second folder (or touch two simultaneously for touch screen) to compare the “sell high—buy low” comparative charting tool.
2302 Title “Folder 1”

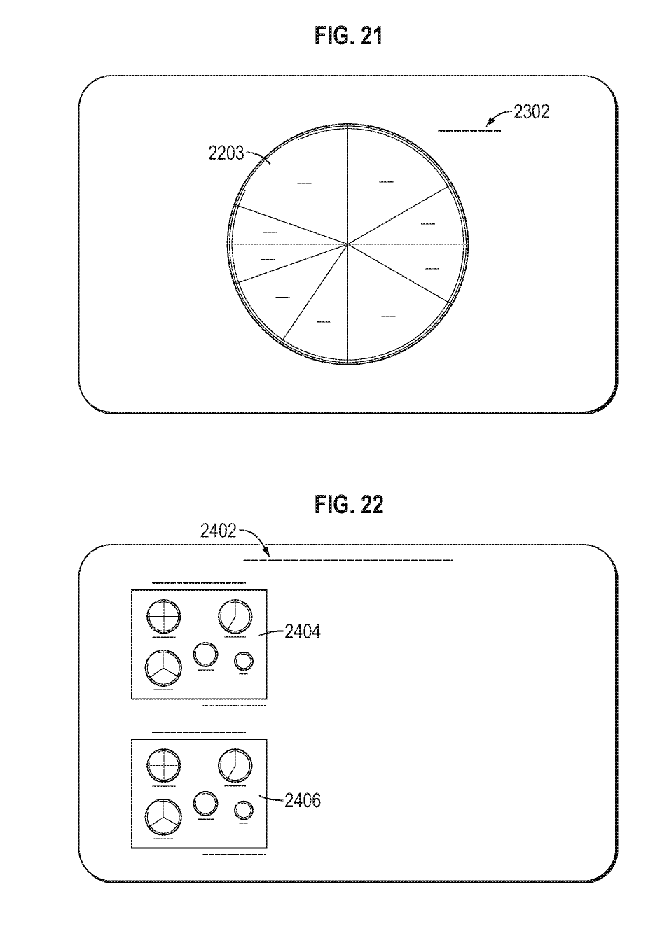

In FIG. 21, click on a segment of the folder to open the trade item for editing or reapportioning. Double click to see the performance chart of a folder, or to change weighting within a folder.
2402 Title “Action Vault”
2404 Portfolio icon titled “Trust 1 Portfolio (Initial Value $75,000, today's value $105,000)
2406 Portfolio icon titled “Trust 2 Portfolio (Initial Value $75,000, today's value $105,000)

In FIG. 22, click any portfolio, or “zoom” to enlarge to see detail. Double click to Edit name. Click folders (pie charts) to see performance charts, make changes, additions, delete, or reapportion your investments. Click “CASH” to add funds to portfolio. Click blank area in the vault green space to add or paste a new portfolio (clicking opens an option box).
2502 user
2504 host
2506 broker
2507 agrees to share relevant information
2508 downloads program and relevant information
2510 creates user profile (can be after broker setup)
2512 saves work
2514 recalls work when requested or on login
2516 can offer to make work available to third parties through “Store”
2518 can initiate “buy request”
2520 solicits bids for buy request or execute through established broker
2522 confirms broker details or initiation of broker set up
2524 notifies host if executed or details of changes
2526 puts into user's “Action Vault” unless modification occurs
2602 digital computer
2604, 2604′, 2604″ displays
2606 communication system
2607 modem
2608 electronic database
2610 application, graphing software, interactive software
2612, 2612′ user input devices
2702 title of slide “Arbitrage Pairings”
2704 bar to enter investment period
2706 bar to enter historical period
2708 window for folder comparison

In FIG. 23, drag and drop two folders to be compared into the relevant area of investment period or historical period. Enter the time in years into the bar. Click enter. Delete pairings by highlighting and deleting. Double tap or click to open charts.
2802 Graph of arbitrage pairing of Sample 1 vs. Sample 2
2804 Slidable vertical bar to set beginning point
2806 Slidable vertical bar to set ending point
2808 Slidable horizontal bar indicating a potential switching point
2810 Slidable horizontal bar indicating a potential monitoring level
2812 Slidable horizontal bar indicating a potential switching point

The pairing chart of FIG. 24 can be used to weight basket investments—full switching or reweighting when one basket is relatively high compared to another favored basket (full switching is the classic arbitrage trading). Remember—buy low, sell high—using the arbitrage pairing chart to assist. The vertical bars can be moved left or right to increase ranges (investment period). Horizontal bars are useful trigger values. More vertical and horizontal bars cans be inserted using ctrl+key, or removed by clicking line and delete.
2902 user
2904 broker
2906 other users
2908 request for proposal
2910 make proposal
2912 request account
2914 offer services agreement
2916 accept agreement
2918 deposit funds
2920 two way flow of information and funds
3002 Screen title: Sample Basket Performance Chart
3004 slider button to set investment start date
3006 slider button to display investment value
3008 slider button to set investment out date
3010 graph of investment value against time
3012 button to electronically access purchase tool

The visual chart of FIG. 26 can be used to test selected stocks and weights, and to make purchases. Click on buttons to enter numerical changes, or drag them to change investment begin date, investment end date, and values.
3102 Screen title: Abitrage pairing: Sample 1 vs Sample 2
3104 Graph of Sample Basket 1 vs. Sample Basket 2 expressed as percentage
3106 Slidable vertical bar to set beginning point
3108 Slidable vertical bar to set ending point
3110 Slidable horizontal bar indicating a potential switching point
3112 Slidable horizontal bar indicating a potential switching point
3114 Slidable horizontal bar indicating a potential monitoring level
3116 Button to open sell/purchase tool
3202 First digital computer
3203 Monitor
3204 Second digital computer
3205 Monitor
3206 Electronic communication system, e.g. internet
3208 App for maintaining client account
3210 App for formulating basket of investibles
3212 input devices for first computer
3214 input devices for second computer
3302 Host
3304 Host program
3306 Opening “Store” Vault
3308 “Store” Vault
3310 My purchased items
3312 The Store Catalog
3314 My “For Sale” folders
3316 Electronic Access Path
3318 Opening Ideas Vault
3320 Ideas Vault
3322 Portfolio Creation
3324 Folder modification
3326 Folder creation
3328 Trade item functions
3330 Apportionments
3332 Reallocations
3334 Assign Vault
3336 Electronic Access Path
3338 Open “Serious Stuff” Vault
3340 Elect to Purchase the portfolio
3342 List Brokers
3344 Select Broker
3346 Make purchase, place in action vault
3348 List folder in store as “for sale”
3350 Open Action vault
3352 Action Vault
3354 open gaming vault
3356 engage in games

The host 3302 electronically provides a software program designed as a visual tool for developing and tracking potential/real investments. Investments are combinations of securities and currencies (trade items) with different relative cash apportionments. The program links directly to databases all offered trade items unit cash values over time, which are used to automatically produce historical investment performance charts of trade items and/or user created folders and/or portfolios. The program offers a user friendly/intuitive platform for creating analyzing, modifying and real-world/gaming of investments. The host electronically provides a store for selling and purchasing public folders for incorporation into a user's portfolios. The program electronically provides pass word protected vaults for organizing portfolio development, the store, executed investments, and gaming. An arbitrage charting tool is integrated into the program to facilitate on-going apportionment decisions between 2 items, 2 folders, or 2 portfolios. Other investment tools that aid investment decision making may also be incorporated to assist the user. The host offers user's “host-contracted” and verified third party brokers that can purchase/trade the trade items (as apportioned using the program) for the user (on the third party website—for well integrated third parties, the broker web format will complement the host software) to execute real world investments. Any changes made by the user directly with the broker cannot be tracked by the program, so such changes result in the broker “removing” the portfolio from the “action” vault.

The host program 3304 is downloaded/opened by a user. The user creates/has a unique sign-in ID and password. Each of the user's vaults also has a unique ID (or common ID I so entered). The user's investment development work, i.e. the content of a vault, is saved on the user's computer, which can be backed up by the host (for a few possibly). Only folders in traded portfolios/active gaming folders are sent to the store, and are automatically saved (free) on the host's site. The host has commercial operating agreements with potential third party brokers, and may receive a referring commission or a share in trade commissions (or other commercial arrangements). Further, the host derives income from the online store. The host may also charge for data streams over a certain display time (e.g. more than a year). The host may also charge for tracking portfolios over time with “structured” pre-formatted reports, or electronically provide certain display time (e.g. more than a year), or electronically provide research tools for a fee.

The store vault 3308 contains three fixed portfolios, “Store Catalog” which incorporates an advanced search engine, “My ‘for sale’ folders” and “My purchased folders”.

“My purchased folders” 3310 contains any folder purchased previously. To edit or incorporate a purchased folder into a personal folder, drag or “copy and paste” it into any other location. Purchased folders remain available indefinitely until deleted by the user.

The “store catalog” 3312 is a library of user generated “folders” that have been traded by the creator (i.e. folders that reside in their originators vault). The on-line store can be browsed using various search options and criteria. Along with tags and a description, the store displays performance charts of folders available for purchase. Purchases are automatically charged to the purchaser's credit card associated with their log-in name and password. Once purchased, the fully populated purchased folder is automatically downloaded from the host onto the user's device.

The user's “for sale” folders have an associated selling price (default is, say, 99 cents) which is set by the user and is shared with the store, providing revenue generation for store. The selling price ceiling is categorized. E.g. a rookie may be $1 up to 10,000 sold may be $5 and up to say, $100 for larger numbers sold. A user can give a description of a folder in the store to “inform” potential buyers of key aspects.

The “Ideas Vault” 3320 electronically provides a storage space where a portfolio can be created, modified, or a performance chart can be generated. In portfolio creation 3322, a new portfolio is named and an initial virtual cash “deposit” can be generated. In a portfolio, an existing folder can be modified at 3324 and/or its performance charted, a new empty folder can be created, a folder can be copied and pasted to replicate an existing folder, or a folder can be purchased in the store from a third party. Folders can be created at 3326, and associated with an identifying name and an allocation of a cash value, the allocation being less than or equal to the investment portfolio cash deposit. Trade item functions 3328 include a “Search and Select” function used to identify new trade items to add in a folder, with trade item performance charts being available for analysis. An existing trade item can be removed from a folder by simple deletion. An Apportionment tool 3330 facilitates cash-allocation between trade items in a folder on a percentage basis. Default is equal apportionment. Cash can be reallocated between folders at 3332 using arbitrage charts or any other means—for example, future tools or personal preferences. Once a portfolio's development is completed, it can be assigned a vault at 3334—for example, moved to the “Serious Stuff” vault for trade execution.

In the Serious Stuff vault 3340, a portfolio is monitored until a decision is made to purchase the portfolio. A broker list 3342 can be opened for selection of a broker. A previous broker used is presented as the first choice, with linking data to the broker being saved on the user's device. Broker selection 3344 is initiated by the user, and the user is transferred to the broker's web site, along with a description of trade items and the value of each to be traded. Once actual trading is completed at 3346 for the portfolio, the broker notifies the host (through prearranged agreements) and the host instructs the program to move/update the executed portfolio into the “Action” vault. Folders in the “Action” vault are automatically at 3348 placed for sale in the “My for sale folders” portfolio in the “store” vault for electronic access and purchase by another other user. To keep something private, and “pay for the site hosting costs” a user can purchase their own folders which renders them invisible to the public. The folder is automatically “tagged” by the store with predetermined characteristics which are searchable by other users. User “details” are also tracked/tagged (such as popularity and number of downloads etc.) The store displays performance charts of a folder available for purchase (a default charting period of 1 year can be used).

In the Action vault 3350, a user can add or remove trade items, reapportion folder items, reallocate, reduce or increase folder cash allocations, changes or additions/removal of folders etc by “trading” the portfolio. This is done by “copy-paste” the action folder into serious stuff folder, and once edited, the program sorts out the most efficient trading scheme to send to the broker to minimize trading quantity.

A gaming vault 3354 is also electronically provided. Gaming is intended for education, discovery of interesting portfolio strategies of others, and fun. Any portfolios entered into games by user are “real world” tracked. Games format are user selected, and entering a game type has an associated fee (revenue generation, prevents bots, and keeps gamers serious.) Games are organized by “user selected experience level”, “portfolio genre”, “game participant size” and “game duration” for example. All games have preset starting dates and ending dates, and preset opportunities to “edit” portfolios for “retrading”. A real-time portfolio value for each participant is shown, so any player can keep track of the performance charts of others. Players can buy each other's folders in the store, or use the performance of others in a game to incorporate new idea into personal investment strategies. A winner of a game is given tokens for free gaming and gets tagged in the store as a “pro” to make successful portfolio builders more “fordable” in the store.
3402 User
3404 Host
3406 Broker
3408 User with program installed and at least 4 vaults set up, and a broker selected, opens “store” portfolio in “store” vault, accesses folders for sale at host site (host's store), uses search engines, etc.
3410 Host sends performance displays of selected folders
3412 User selects and pays for a folder
3414 Host automatically downloads selected full details folder to “purchased folders” portfolio in user's “store” vault
3416 User can work the purchased folder, modifying it if desired, moves it to the “serious stuff” vault, and electronically transmits the folder back to host to initiate a purchase
3418 After comparison to user's other folders, the folders are automatically populated to the “store” at the host site and the portfolio is electronically transmitted to the broker for purchase
3420 Broker purchases portfolio contents for user's account and electronically transmits notice to host
3422 Host screens folders and makes the ones that are not substantial copies of existing folders available for third party purchase of details. Host notifies user of which folders have been accepted or rejected for store “inclusion” and automatically populates the accepted folders into user's “for sale” portfolio in the store vault. Host automatically updates and locks the contents of the portfolio in the user's action vault from modification by the user, and prompts user to set prices for items populated to the “for sale” portfolio.
3422 User electronically transmits price information to host, and the host associates the price information with the folders so that the user can be paid when the portfolios are purchased by third parties
3502 User
3504 Host
3506 Broker
3508 User with program installed and at least 4 vaults set up, and a broker selected, copies a portfolio from the “Action Vault” and pastes it, for example, in the “Serious Stuff” vault. The user makes modification and presses “Buy”. The portfolio is sent to the host. The Program determines if it is a modified portfolio or is substantially the same as an existing portfolio. If yes, the user is queried as to whether replacement is intended. The host analyzes the portfolio and holdings to determine the sales and purchases needed to complete the order.
3510 Instruction to make the sales and purchases to complete the order are electronically transmitted to the broker.
3512 The broker executes the trades for the user's account and sends notice to the host.
3514 The host screens the folders and makes the ones that are not substantial copies available for third party purchase by adding to the user's “for sale” portfolio. The host prompts the user to set prices to for the folders made available for purchase. If replacement was intended (step 3508), the portfolio to be replaced is deleted and replaced with the new portfolio and the Action Vault is locked. If replacement was not intended, the new portfolio is added to the Action Vault and the Vault is locked.
3516 The user electronically transmits price information to the host and the host associates the price information with the folders so that the user can be paid when portfolios are purchased by third parties. The host may delete folders that are not longer owned by user from the store.
3602 User
3604 Broker
3608 Host
3610 User with program installed, at least 4 vaults set up, and a broker selected, opens the “Ideas Vault”, forms a virtual basket, copies it to the “Serious Stuff” vault, and forms a portfolio based on the basket or a modified form, and electronically transmits it to the broker with an indication to purchase.
3612 Broker fills the order and notices host
3614 Host populates the purchased portfolio into the user's “For Sale” portfolios in the store vault. Host updates and locks user's Action Vault.
3616 User electronically transmits pricing information to the Host for the newly populated “for sale” portfolio
3618 Host makes electronic payments to user for sale of portfolio information
3702 Host computer system
3704 External data server being drawn on by Host computer system
3706 Single player
3708 Team 1 players
3710 Team 2 players
3712 First player
3714 Second player
3802 Open “Ideas Vault”
3804 In vault, create an investment Portfolio, “Deposit” investment cash amount
3806 In Portfolio, create a new empty folder, copy and paste an existing folder from another portfolio, or import (buy) a folder from a third party. Allocate a cash value to the folder that is less than or equal to the investment portfolio cash deposit.
3808 Select trade item to place in folder, using historical performance charts as guides
3810 Apportion folder cash allocation between trade items (relative 5). Default is equal apportionment.
3812 Reallocate cash (if desired) between folders, using “arbitrage charts” or any other means (future tools or personal preferences)
3814 Once portfolio makeup is completed and the historical performance has been reviewed, the portfolio can be moved in the “serious stuff” vault for potential “trade execution”
3816 Decision is made to “Purchase” portfolio using a broker, or “gaming”
3818 A list of available brokers is presented for selection. Previous selection detail is offered as first choice, with previous user data saved on local device.
3820 Broker is selected by user, and user is transferred to broker web site, along with trade items and value of each to be traded.
3822 Once “actual” trading is completed for complete portfolio, broker “moves” the executed portfolio into the “action” vault
3824 User can add or remove trade items, reapportion folder items, reallocate, reduce or increase folder cash allocations, changes or additions/removal of folders etc. by “trading” the portfolio
3826 Any changes made by the user directly with the broker cannot be tracked by the program, so such changes result in the broker or host “removing” the portfolio from the “action” vault
3902 Title of window “Sample Basket Performance Chart”
3903 chart
3904 Title of window “Selected Components weighting of sample basket”
3905 pie chart showing weighting
3906 investment begin date slider button
3908 investment end date slider button
3910 Button to electronically access reapportionment tool

In FIG. 35, the weighting is set at the begin date. It can be changed manually by dragging the radii on the pie charge. It will then change automatically depending on the end date selected.
4002 Title of screen Reapportionment strategies
4004 Title of window Revert to initial weighting every ______ days
4006 Title of window Revert to initial weighting if any stock's value changes >______%
4008 Title of window Replace ______% of worst stock with best stock every ______ days
4010 Title of window Go to custom reapportionment screen
4012 Save and go back one screen button

1. A method for electronically displaying an algorithmically updated cashout value graph over time, for a virtual or real investment made at a specified date and time of an allocated amount in an electronically tradable investible, said method comprising
selecting, by use of a digital computer program accessing a digital information highway, an electronically tradable investible for which a data set of historical unit trading prices is available from an electronic database accessible by the digital computer,
electronically downloading and/or accessing the data set in the electronic database by the digital computer program,
providing, for use by the digital computer program, a numerical value for the allocated cash amount to be invested in the electronically tradable investible,
providing, for use by the digital computer, an investment start date and time for the virtual or real investment in the electronically tradable investible,
calculating, by use of the digital computer, by dividing the numerical value of the amount to be invested by the unit price of the tradable security at the investment start date and time, the number of investment units in the electronically traded investible, and
displaying, on an electronic display associated with the digital computer, a graph of virtual or real investment cashout values as a function of date and time, over time, for the virtual or real investment,
wherein the cashout value graph, backward and, data permitting, forward, from the investment start date and time, over the date range, is generated algorithmically by the digital computer program based on the calculated number of investment units, the investment start date and time and the historical unit trading-prices accessed by the digital computer from the electronic database.

2. A method as in claim 1 wherein the cashout value graph is further based on predetermined reallocation strategies executed at different times over the date range.

3. A system for displaying a cashout value graph over time for a virtual cash investment of an allocated amount at a specified time and date in an electronically tradable investible, said system comprising
a digital computer,
trade-price data for the electronically tradable investible, against time, stored in a database accessible by the digital computer,
an electronic display operatively associated with the digital computer,
graphing software operatively associated with the digital computer for processing the database and displaying a virtual investment cash-out value graph over time for the virtual investment at a specific time and date in the electronically tradable investible;
interactive input software operatively associated with the digital computer for accepting an initial or a revised virtual or real investment cash allocation and an initial or a revised specific starting date and time for the cash-out value graph, and
at least one user input device for inputting an initial or revised virtual investment cash allocation and an initial or a revised virtual investment date for the cash-out value graph.

4. A method for displaying a graph representative of performance over time of a collection of electronically tradable investibles in a virtual basket comprised of apportioned/weighted percentage holdings of electronically tradable investibles presented as percentage proportions of the total virtual basket, said basket being comprised of at least a first electronically tradable investible and a second electronically tradable investible, said method comprising
providing, for use by the digital computer, an investment starting date for the basket,
selecting, by use of a digital computer, a first electronically tradable investible for which a data set of historical unit trade-prices is available from an electronic database accessible by the digital computer on a digital information highway,
accessing the data set for the first electronically tradable investible on the digital computer from the electronic database for use in calculating cash-out value for the basket,
selecting, by use of a digital computer, a second electronically tradable investible for which a data set of historical unit trade-prices is available from an electronic database accessible on a digital information highway,
accessing the data set for the second electronically tradable investible on the digital computer from the electronic database for use in calculating cash-out value for the basket,
apportioning weightings for the at least the first electronically tradable investible and the second electronically tradable investible to make up the basket on the basis of percentages, the sum of all electronically tradable investibles, making up the basket being selected from unity, 100 percent, or an allocated cash value for the basket as of the investment starting date,
displaying, on an electronic display associated with the digital computer, a cashout value graph illustrating the historical cashout value for the total basket backward and, data permitting, forward from investment starting date, and the relative apportionment of each component of the basket.

5. A method as in claim 4 further comprising
selecting, by use of the digital computer, a predetermined reallocation strategy for reapportioning the weightings for the at least the first electronically tradable investible and the second electronically tradable investible upon the occurrence of a triggering event, and
reapportioning the weightings according to the strategy upon each occurrence of the triggering event, if any.

6. A method as in claim 4 wherein the sum of all electronically tradable investibles making up the basket is 100 percent as of the investment starting date.

7. A method as in claim 4 wherein the cash-out value graph electronically visually stacks apportioned weightings for each of the electronically tradable investibles separately.

8. A method as in claim 7 wherein cash-out value graph electronically separately color codes an apportionment for each component of the basket.

9. A system for displaying a cash value graph representative of performance over time of an virtual or real investment in a basket comprised of weighted amounts of at least a first electronically tradable investible and a second electronically tradable investible, said system comprising
a digital computer,
an electronic display operatively associated with the digital computer,
a communication system operatively associated with the digital computer and connected to a digital information highway,
an electronic database containing data sets of historical unit values for at least a first electronically tradable investible and a second electronically tradable investible accessible from the digital computer via the communication system,
an application on the digital computer for retrieving the data sets and mathematically forming a virtual basket comprised of weighted percentages of the first electronically tradable investible and the second electronically tradable investible,
graphing software operatively associated with the digital computer for displaying a cash value graph of the cash value of the virtual basket against time on the display, interactive software operatively associated with the digital computer for accepting a starting cash value and a starting date for the virtual basket, and
at least one user input device for inputting the starting cash value and the starting date for the virtual basket.

10. A system for displaying a cash-out value graph representative of performance over time of a virtual or real investment in a portfolio comprising at least two virtual baskets each comprised of weighted amounts of electronically tradable investibles, said system comprising
a digital computer,
an electronic display operatively associated with the digital computer,
a communication system operatively associated with the digital computer and connected to a digital information highway,
an electronic database containing data sets of historical unit values for each of the electronically tradable investibles accessible from the digital computer via the communication system,
an application on the digital computer for retrieving the data sets and forming mathematical models of the virtual baskets,
an application on the digital computer for combining the mathematical models of the virtual baskets and forming a mathematical model of the portfolio,
graphing software operatively associated with the digital computer for displaying a cash-out value graph of the cash-out value of the portfolio against time on the display, and
software operatively associated with the digital computer for accepting a starting cash value and a starting date for each of the virtual baskets.

11. A system as in claim 10 wherein the graphing software visually stacks cash-out value contributions from each of the virtual baskets.

12. A system as in claim 11 wherein the graphing software separately color codes cash-out value contributions from each of the virtual baskets.

13. A method for reallocating weighted cash-out values to a first electronically tradable investible and a second electronically tradable investible in a virtual basket comprising at least a first and a second electronically tradable investible, said basket having an overall cash-out value, said method comprising
displaying, on an electronic display operatively associated with a digital computer, a unity diagram having an area representing 100% of the overall cash-out value of the basket,
displaying, on the unity diagram, at least one divider element dividing the area into at least two subareas proportionally representing weighted cash values for the first electronically tradable investible and the second electronically tradable investible,
adjusting the size of one of the subareas with a user input device coupled to a digital computer, and
adjusting the size of the at least one other subarea with a self-executing software application residing on the digital computer.

14. A method as in claim 13 wherein the adjustment is entered by moving the divider element to a new location on the area by use of a user input device operatively associated with the display, and
immobilizing the divider element in the new location by use of the user input device to reallocate the weighted cash-out values between the first electronically tradable investible and the second electronically tradable investible, wherein the subareas proportionally represent the reallocated cash-out values.

15. A method as in claim 13 wherein the adjustment is entered by selecting an area with a user input device and entering a numerical allocation with the same or a different user input device.

16. A method for displaying change over time for relative contributions by individual components making up a virtual basket of at least a first electronically tradable investible and a second electronically tradable investible, said method comprising
accessing data sets of historical unit trade-prices for the components of the virtual basket by use of a digital computer,
accessing weightings for the components of the basket on the basis of part of the whole, or percentages, as of an investment starting date, the sum of all components being selected from unity, 100 percent, and a virtual or real investment cash-out value,
displaying, on an electronic display operatively associated with a digital computer, a unity diagram having an area representing 100% of the overall cash-out value of the basket at any given time, and
displaying, on the unity diagram, at least one divider element dividing the area into at least two subareas proportionally representing weighted cash-out values for each of the components of the basket at any given time supported by the data sets.

17. A method as in claim 16 wherein the sum of all components is 100 percent.

18. A method as in claim 17 further comprising displaying a graph of the performance of the basket against time alongside the unity diagram.

19. A method for displaying relative historical cash-out value differences and trends in virtual cash-out value between a first virtual or real basket comprising at least one first electronically tradable investible and a virtual or real second virtual basket comprising at least one second electronically tradable investible, said method comprising
establishing a first virtual or real basket comprising at least one first electronically tradable investible for which a first data set of historic cash values is available from an electronic database,
establishing a second virtual or real basket comprising at least one second electronically tradable investible for which a second data set of historic cash values is available from an electronic database,
electronically accessing the first data set and the second data set onto the digital computer from the electronic database,
setting equal at unity initial virtual investment starting cash values for the first virtual or real basket and the second virtual or real basket,
selecting, by use of the digital computer, a virtual or real investment starting date for the initial virtual or real starting cash value,
displaying, on an electronic display associated with the digital computer, a cash value graph of the difference in change between the first virtual or real basket cash value and change in the second virtual or real basket cash value, said difference being expressed as a percentage change, against time, forward and/or backward from the virtual or real investment starting date.

20. A method as in claim 19 wherein
wherein the first virtual basket represents a real investment, and
wherein the second virtual basket represents a virtual investment.

21. A method as in claim 19 wherein the at least one first electronically tradable investible and the at least one second electronically tradable investible are selected so that the relative value graph oscillates up and down over time, the graph being representative of the relative values of the baskets and having portions indicative of arbitrage or reweighting opportunities.

22. A system for displaying relative price differences and trends in value between a first virtual basket comprising at least one first electronically tradable investible and a second virtual basket comprising at least one second electronically tradable investible, said system comprising
a digital computer,
an electronic display operatively associated with the digital computer,
a communication system operatively associated with the digital computer,
an electronic database accessible by the digital computer via the communication system containing digital data sets of historical unit values for the first electronically tradable investible and the second electronically tradable investible,
an application on the digital computer for accessing the data sets and displaying, on the display, a graph of a difference in change between a first virtual or real investment cash value and change in a second virtual or real investment cash value, said difference expressed as a percentage change, against time,
interactive software operatively associated with the digital computer for accepting an initial or revised virtual or real investment starting date for the cash value graph, and
at least one user input device for inputting the initial or a revised starting date, said first basket and said second basket being of the same virtual or real investment starting cash value as of the initial or revised investment starting date.

23. A method comprising
electronically receiving, from a user, a description of a user-defined virtual investment portfolio, said portfolio comprising at least one virtual basket, each said at least one virtual basket having a virtual investment starting cash value and having a composition comprising weighted amounts of least a first electronically tradable investible and a second electronically tradable investible, the identity and weighted amount of each electronically tradable investible being included in the description,
electronically receiving, from the user, an indication of a desire to purchase the composition of portfolio, and
electronically making available to a broker an order to purchase the composition of the portfolio for the user.

24. A method as in claim 23 wherein the weighted amounts are expressed as percentages of the virtual investment starting cash value, an aggregate of weighted amounts tallying 100% of the virtual investment starting cash value.

25. A method comprising
at a broker's computer, electronically receiving, from a host, a description of a user-defined virtual investment portfolio, said portfolio comprising at least one basket, each said at least one basket having a virtual investment starting cash value and having a composition comprising weighted amounts of at least a first electronically tradable investible and a second electronically tradable investible, and
electronically receiving, from the host, on behalf of a user, an order for the composition of the portfolio.

26. A method as in claim 25 wherein, when the order is electronically filled, the amounts of each of the at least a first electronically tradable investible and a second electronically tradable investible in each basket, as measured in units, are adjusted to conform to the virtual investment starting cash value for the basket.

27. A method as in claim 25 wherein the weighted amounts are predetermined on a percentage basis and the description includes a description of the weighted amounts of the at least a first electronically tradable investible and second electronically tradable investible.

28. A method comprising, at a broker's computer,
electronically receiving a request to establish an electronic user account,
establishing the account,
electronically receiving, from the user, a description of a user-defined virtual investment portfolio, said portfolio comprising at least one basket, each said at least one basket having a virtual investment starting cash value and having a composition comprising weighted percentages of at least a first electronically tradable investible and a second electronically tradable investible, and
electronically receiving, from the user, a order to purchase, for the user's account, the composition of the virtual investment portfolio.

29. A method as in claim 28 wherein the weighting is expressed as percentages of the virtual investment starting cash value, an aggregate of weighted amounts tallying 100% of the virtual investment starting cash value.

30. A method as in claim 29 further comprising electronically executing the order and adjusting the amounts of each of the at least the first electronically tradable investible and the second electronically tradable investible in each basket, as measured in units, to conform to the virtual investment starting cash value for the basket.

31. A remotely electronically accessible program or internet web page sponsored by a host site for posting user-defined virtual investment basket performance information,
said basket having a composition comprising weighted amounts of at least a first electronically tradable investible and a second electronically tradable investible, wherein the weighting is determined at a certain specified time,
said basket performance information being presented as an image on a user electronic display and having a hot area to receive a purchase command for electronically transmitting to the host site,
and executing the purchase command by the user electronically provides, on an electronic display associated with a digital computer of the user, an image of a default cash value graph of the value of the basket against time and hot areas to adjust the composition weighting of the basket and an investment starting date and time for the basket.

32. A program as in claim 31 which electronically provides options for a user to select automatic reapportionment strategies for automatically adjusting the composition weighting of the basket.

33. A remotely electronically accessible program or internet web page sponsored by a host site for posting user-defined virtual investment basket pairing performance information,
wherein each virtual basket pairing comprises
a first virtual basket comprising at least one first electronically tradable investible, and a second virtual basket comprising at least one second electronically tradable investible,
said remotely electronically accessible program or internet web page being presented via the internet as an image on a user electronic display of a default cash value graph of the difference in change in first virtual basket starting unitary cash value and change in second virtual basket starting unitary cash value, said difference being expressed as percentage change, said image further including a hot area to electronically transmit an electronic access command to receive a description of the first virtual basket and the second virtual basket,
said image further including hot areas for receiving commands to adjust the starting cash value of each basket and the investment starting date for each basket.

34. A remotely electronically accessible program or internet web page as in claim 33 wherein the first virtual basket represents a virtual basket for virtual sale and the second virtual basket represents a virtual basket for virtual purchase.

35. A method for displaying value changes of an initial virtual or real investment in an electronically tradable investible, said method comprising
providing a system comprising a digital computer, cash-out value against time data for at least one electronically tradable investible stored in a database accessible by the digital computer, an electronic display operatively associated with the digital computer, graphing software operatively associated with the digital computer for processing the database and displaying a cash-out value graph of the at least one electronically tradable investible against time on the display, interactive input software operatively associated with the digital computer for accepting an initial or revised starting cash value and an initial or revised investment starting date for the cash-out value graph and at least one user input device for inputting the initial or revised starting cash value and the initial or revised investment starting date, for the cash-out value graph
electronically receiving the cash value against time data for the at least one electronically tradable investible,
receiving inputs establishing the initial or revised starting cash value for the cash value graph,
processing, by use of the digital computer, the cash value against time data, the initial or revised starting cash value, and the initial or revised investment starting date with the graphing software, and
displaying the cash value graph of the changes in cash value over time based on the initial or revised starting cash investment on the display.

36. A method for forming a virtual basket comprising a first electronically tradable investible and a second electronically tradable investible, said method comprising providing a digital computer, an electronic display operatively associated with the digital computer, a electronic communication system operatively associated with the digital computer, an electronic database containing data sets of historical unit values for at least a first electronically tradable investible and a second electronically tradable investible accessible from the digital computer via the electronic communication system, an application on the digital computer for retrieving the data sets and mathematically forming a virtual basket comprising weighted percentages of the first electronically tradable investible and the second electronically tradable investible, graphing software operatively associated with the digital computer for displaying a cash-out value graph for the virtual basket against time on the display, interactive software operatively associated with the digital computer for accepting an initial or revised starting cash value and an initial or a revised investment starting date for the cash value graph, and at least one user input device for inputting the initial or the revised starting cash value and the initial or the revised investment starting date for the cash value graph,
accessing the data sets,
receiving inputs establishing the initial or a revised starting cash value and an initial or a revised investment starting date for the cash value graph,
receiving inputs establishing the initial weighted percentages of at least a first electronically tradable investible and the second electronically tradable investible and an initial or a revised investment starting date for the cash value graph,
processing the data sets, the initial or revised starting cash value, and the initial or revised investment starting date with the graphing software, and
displaying the cash-out value graph for the virtual basket over time based on the initial or revised virtual or real investment starting cash value and initial or revised investment starting date on the display.

37. A method as in claim 36 further comprising receiving inputs establishing a revised weighted percentage of the at least a first electronically tradable investible and the second electronically tradable investible, said revised weighted percentages being established upon reaching at least one trigger point according to a predetermined reweighting strategy, wherein the cash-out value graph is further based on the revised weighted percentages and the time at which the trigger points are reached.

38. A method for allocating apportioned starting cash values for a first electronically tradable investible and a second electronically tradable investible making up a virtual basket, said method comprising
providing a digital computer, an electronic display operatively associated with the digital computer, an electronic database containing data sets of historical unit values for at least a first electronically tradable investible and a second electronically tradable investible; an application on the digital computer for retrieving the data sets and mathematically forming a virtual basket comprising weighted percentages of the first electronically tradable investible and the second electronically tradable investible, cash value graphing software operatively associated with the digital computer for displaying a cash value graph for the virtual basket against time on the display, interactive software operatively associated with the digital computer for accepting an initial or revised starting cash value and initial or revised investment starting date for the cash value graph, interactive software operatively associated with the digital computer for displaying, on the display, an unity diagram representing 100% of the starting cash value of the basket, interactive software operatively associated with the digital computer for displaying, on the unity diagram, at least one movable divider element dividing the area into subareas proportionally representing apportioned starting cash values for the first electronically tradable investible and the second electronically tradable investible, interactive software for moving the divider element or otherwise adjusting the apportionment and for inputting an initial or a revised starting cash value and an initial or a revised investment starting date for the basket,
receiving a command to reallocate the apportioned starting cash values between the first electronically tradable investible and the second electronically tradable investible,
recalculating the cash value graph in view of the reallocated cash values, and
displaying the recalculated cash value graph.

39. A method as in claim 38 further comprising
providing the digital computer interactive software to program a reapportionment strategy for causing an automatic reapportionment between the first electronically tradable investible and the second electronically tradable investable based on the occurrence of a triggering event,
programming the strategy,
receiving notification of a triggering event, and
executing the reapportionment strategy.

40. A method for displaying relative price differences and trends in value between a first virtual basket and a second virtual basket, said method comprising
providing a digital computer, an electronic display operatively associated with the digital computer, an electronic database containing data sets of historical unit values for a first virtual basket comprising at least first one electronically tradable investible and a second virtual basket comprising at least one second tradable item, an application on the digital computer for retrieving the data sets and displaying, on the display, a graph of the difference in change between first virtual basket cash value and change in second virtual basket cash value, said difference being expressed as percentage change, interactive software operatively associated with the digital computer for accepting an initial or a revised investment starting date for the graph, said virtual baskets being set at equal starting cash value as of the initial or the revised investment starting date, and at least one user input device for inputting the initial or the revised investment starting date,
receiving the data sets in the digital computer,
receiving an input establishing the initial or the revised investment starting date for the graph in the digital computer,
processing the data sets and the investment starting date with the graphing software, and
displaying the graph of the difference in change between the value of the first virtual basket and the second virtual basket on the electronic display operatively associated with the digital computer.

41. An online securities trading system, said system comprising
a first digital computer,
a second digital computer,
an electronic communication system functionally connecting the first digital computer with the second digital computer,
an application on the first digital computer for establishing and maintaining an online trading account for a client; said application accommodating purchases and cash-out value tracking for at least one client portfolio, said portfolio comprising at least one client-specified basket, said at least one client-specified basket comprising client-proportioned percentages of at least a first electronically tradable investible and a second electronically tradable investible, said basket being established in an initial virtual or real investment amount specified by the client, and
an application on the second digital computer for selecting at least first and second electronically tradable investibles for which data sets of historical unit values are available from an electronic database, downloading the data sets, and forming a virtual basket comprising weighted percentages of the first electronically tradable investible and the second electronically tradable investible, incorporating the virtual basket into a virtual portfolio, and electronically transmitting data describing the virtual portfolio over the electronic communication system to the first digital computer for inclusion in the online trading account in the initial virtual or real investment amount.

42. A system comprising a computer program operating in conjunction with a digital computer system to electronically provide a visual interface displaying screen icons which locate hot areas for launching password-protected virtual electronic workspaces, one icon for each hot area, one hot area for each virtual electronic workspace, wherein providing the password and entering the virtual electronic workspace launches an application and permits electronic access to subdirectories containing data utilised by the launched application to calculate and display performance graphs on the visual interface for virtual baskets of investments, each virtual basket comprised of apportioned/weighted percentage holdings of electronically tradable investibles presented as percentage proportions of the total virtual basket, each basket being comprised of at least a first electronically tradable investible and a second electronically tradable investible.

43. A system as in claim 42
wherein the visual interface has an icon identifying electronic access to a password-protected “Store” virtual electronic workspace comprising a first “Store” subdirectory which electronically provides an electronic display containing hot areas for accessing performance graphs for baskets at a third party website, a “Purchased Baskets” subdirectory which electronically provides an electronic display containing hot areas for accessing graphs for previously purchased baskets from the third party website, and a “For Sale” subdirectory which electronically provides on the display a listing of royalty-generating baskets for sale on the third party web site.

44. A system as in claim 43 wherein the visual interface has an icon identifying electronic access to a password-protected “Ideas” virtual electronic workspace which contains sub-directories listing virtual investment portfolios comprised of at least a first electronically tradable investible.

45. A system as in claim 43
wherein the visual interface has an icon identifying electronic access to a password-protected “Serious Stuff” virtual electronic workspace which comprises subdirectories of virtual investment portfolios at least some of which are comprised of at least one basket comprised of weighted amounts of at least a first electronically tradable investible and a second electronically tradable investible.

46. A system as in claim 43 wherein the visual interface has an icon identifying electronic access to a password-protected “Action” virtual electronic workspace which comprises third-party locked subdirectories modeling real-world investment portfolios at least some of which are comprised of at least one basket comprised of weighted amounts of at least a first electronically tradable investible and a second electronically tradable investible.

47. A method comprising
electronically providing, on a user's computer screen display, icons for,
a password-protected “Store Vault” comprising a virtual electronic workspace providing electronic access to resources for acquiring data on electronically tradable investibles,
a password-protected “Ideas Vault” comprising a virtual electronic workspace for developing formulations of investibles,
a password-protected “Serious Stuff Vault” comprising a virtual electronic workspace for testing the formulations and providing a means of electronically transmitting such formulations to a third party for real world trading,
a password-protected “Action Vault” comprising a virtual electronic workspace providing an archive of past and current investments in the formulations,
and a password-protected “Games Vault” comprising a virtual electronic workspace providing electronic access to investment games involving user-developed formulations against third parties.

48. A method as in claim 47 wherein the Store Vault provides electronic user access to performance information at a remote third-party site to baskets each comprised of weighted amounts of electronically tradable investibles and the ability to pay for and download detailed composition information for selected baskets.

49. A method as in claim 47 wherein the Serious Stuff Vault electronically provides the capability of accepting detailed basket information from other vaults by pasting and of modifying and saving the modified information for later access, and of copying and pasting the detailed information into other vaults, and further of electronically transmitting the portfolio information to a third-party site with a request to execute purchase of the composition of the basket.

50. A method as in claim 47 wherein portfolio details are automatically transferred from the Serious Stuff Vault to the Action Vault following validation of a suitable purchase and an electronic lock on the basket information that relates to the make-up of the basket is accepted from the third party site once notification of execution has been received from the third party site.

51. A method comprising
providing, on a user's computer,
a password-protected “Ideas Vault” virtual electronic workspace including a operably associated computer memory area,
a password-protected “Serious Stuff Vault” virtual electronic workspace including an operably associated computer memory area,
and
a password-protected “Action Vault” virtual electronic workspace including an operably associated computer memory area,
wherein the Ideas Vault provides electronic user access to data sets of historical unit trading prices for electronically tradable investibles and the ability to form virtual baskets of weighted amounts of electronically tradable investibles, adjust the weightings, and graph the past performance of the baskets, and to form virtual portfolios containing at least one virtual basket, and to save information for subsequent use,
wherein the Serious Stuff Vault electronically provides the capability of accepting detailed virtual basket and virtual portfolio information by pasting and of modifying and saving the modified information for later access, of forming and modifying virtual baskets and virtual portfolios, of copying and pasting the detailed information into other vaults, and to save the information for subsequent use, and of electronically transmitting the virtual basket and virtual portfolio information to a third-party site with a request to execute purchase of the composition of the virtual basket and/or virtual portfolio,
wherein the Action Vault has the capability of automatically accepting detailed basket and portfolio information from other vaults and of accepting an electronic lock on the portfolio and basket information that relates to their make-up from the third party site once notification of execution has been received from the third party site,
said method comprising
electronically forming a virtual basket of weighted amounts of electronically tradable investibles in the Ideas Vault on the user's computer,
electronically copying the detailed composition information for the virtual basket,
electronically pasting detailed basket composition information into the Serious Stuff Vault on the user's computer,
electronically forming a portfolio including the virtual basket, or a modified form of the virtual basket, in the Serious Stuff Vault on the user's computer, and
electronically transmitting a copy of the portfolio information from the Serious Stuff Vault to the third party site with an indication of interest in purchasing the composition of the portfolio.

52. A method as in claim 51 which is conducted as part of a game, said method further comprising
providing, on the user's computer,
a password-protected “Games Vault” virtual electronic workspace including an operably associated computer memory area,
accessing portfolio performance information at the third party site of portfolios all formed on the same date by multiple third parties as a part of the game.

53. A method as in claim 51 further comprising providing on the user's computer a password-protected “Store Vault” virtual electronic workspace including an operably associated computer memory area,
wherein the Store Vault further provides an electronic operably associated computer memory area for storing basket identity information from the Action Vault that is offered for sale at the host site,
said method further comprising
electronically receiving at the user's computer basket identity information from the host site of the baskets in the Action Vault that are offered for sale at the host site, and
populating the area of computer memory electronically provided for storing such information.

54. A method as in claim 53 further comprising
electronically transmitting from the user's computer to the host site pricing information for the sale of basket information to the host site, and
receiving electronic payments from the host site at the user's computer for the sale of basket information.

55. A method comprising
electronically providing, on a user's computer screen, separate icon-access to a password-protected “Ideas Vault” virtual electronic workspace including an operably associated computer memory area,
a password-protected “Serious Stuff Vault” virtual electronic workspace including an operably associated computer memory area, and
a password-protected “Action Vault” virtual electronic workspace including an operably associated computer memory area,
wherein the Ideas Vault electronically provides user access to data sets of historical unit trading prices for electronically tradable investibles, and the ability to form virtual baskets of weighted amounts of electronically tradable investibles, adjust the weightings, and graph the past performance of the baskets, and to form virtual portfolios containing at least one virtual basket, and to save information for subsequent use,
wherein the Serious Stuff Vault electronically provides the capability of accepting detailed basket and portfolio information from other vaults by pasting and of modifying and saving the modified information for later access, of forming and modifying baskets and portfolios, of copying and pasting the detailed information into other vaults, and to save the information for subsequent use, and of transmitting basket and portfolio formulation information to a third party for execution of purchase of the investibles.
wherein the Action Vault electronically provides a lock on the portfolio and basket information that relates to their make-up from the third party site once notification of execution has been received from the third party site,
said method comprising, by use of the user's computer,
electronically copying a portfolio in the Action Vault,
electronically pasting the copied portfolio into the Serious Stuff Vault,
electronically modifying the portfolio in the Serious Stuff Vault,
electing whether the modified portfolio is to replace the originally copied portfolio, and, if yes, pressing the hot button and electronically transmitting the modified portfolio to the third party site with instructions to replace the originally copied portfolio in a suitably optimized manner which minimizes trading volume to achieve the new desired formulation.

56. A method as in claim 55 further comprising
electronically determining, at the third party site, the parts of the portfolio to be retained and to be replaced,
electronically executing the retentions and replacements,
electronically notifying the user of the execution, copying the portfolio to the Action Vault, and locking the portfolio in the Action Vault from changes, and electronically posting any new baskets that are determined to be available for third party inspection at the host site.

57. An online store electronically offering for sale an inventory of different virtual investment basket formulations originating from different authors, said virtual investment basket formulations each comprising a number of units of each of at least a first electronically traded investible and a second electronically traded investible, with specified relative weightings at a specific point in time, in electronic form.

58. An online store as in claim 57 wherein the numbers of units are determined by the specified relative weightings at the specific point in time, the relative weightings fluctuating over time.

59. An online store as in claim 58 wherein at least one of said virtual investment baskets further includes a reapportionment strategy for automatically changing the relative weightings of the first electronically traded investible and the second electronically traded investible, upon the occurrence of predetermined triggers, in electronic form.

60. An online store as in claim 57 which causes to be displayed on a user's electronic display device, for viewing by the user, a historical performance chart of a virtual investment basket only, which can be adapted for more specific viewing requirements by the user and a means for the user to electronically purchase a detailed description of the formulation of virtual investment basket.

61. A method comprising
providing an online game forum for a virtual investment portfolio competition, each portfolio comprised of virtual baskets of electronically traded investibles,
posting rules on the online game forum for conducting the competition, including the start date and ending terms,
providing downloadable software for forming the virtual investment portfolios,
receiving virtual investment portfolios online from competitors for entry into the competition prior to the start date,
starting the competition,
making performance graphs available on-line for portfolios entered into the competition,
ending the competition, and
posting a winner of the competition on the game forum.

62. A method as in claim 61 wherein the rules for conducting the competition further permit amending the portfolio composition, said method further comprising receiving, during the course of the competition, amendments to portfolio compositions as permitted by the rules.

63. A method as in claim 61 wherein the downloadable software electronically provides a user having a digital computer and electronic access to a digital information highway with means for
forming portfolios from aggregations of baskets, and
evaluating baskets, by
providing, for use by the digital computer, an investment starting date for the basket,
selecting, by use of a digital computer, a first electronically tradable investible for which a data set of historical unit trade prices is available from an electronic database accessible on a digital information highway,
accessing the data set for the first electronically tradable investible on the digital computer from the electronic database for use in calculating performance for the basket,
selecting, by use of a digital computer, a second electronically tradable investible for which a data set of historical unit trade prices is available from an electronic database accessible on a digital information highway,
accessing the data set for the second electronically tradable investible on the digital computer from the electronic database for use in calculating performance for the basket,
apportioning weightings for the at least the first electronically tradable investible and the second electronically tradable investible to make up the basket on the basis of percentages, the sum of all electronically tradable investibles making up the basket being selected from unity, 100 percent, or an allocated cash value for the basket as of the investment starting date,
displaying, on an electronic display associated with the digital computer, a cash-out value graph illustrating the historical cash-out value for the total basket backward and, data permitting, forward from investment starting date, and the relative apportionment of each component of the basket.

64. A method as in claim 61 wherein competitor basket compositions are available online for a fee.

65. A method conducted on a computer system including any required software and any required electronic access to databases and brokers, said method comprising
(a) opening a virtual “Ideas Vault”
(b) creating a virtual investment portfolio in the vault
(c) allocating a virtual investment amount to the portfolio
(d) creating a virtual basket in the portfolio
(e) allocating part of the investment amount to the basket
(f) selecting a virtual investible for the basket
(g) repeating step (f) with different investibles to populate the basket, and
(h) apportioning the basket cash allocation between the investibles on a percentage basis.

66. A method as in claim 65 further comprising
(i) selecting a broker, and
(j) electronically executing purchase of portfolio.

67. A method as in claim 66 further comprising
devising a reallocation strategy to automatically reapportion cash allocation between the investibles upon the occurrence of a triggering event.

68. A method as in claim 67 further comprising electronically transmitting the reallocation strategy to the broker for automatic execution of the reallocation strategy upon the occurrence of the triggering event.
